(19) United States
(12) Patent Application Publication
(10) Pub. No.: US 2005/0022631 A1
(43) Pub. Date: Feb. 3, 2005

(54) Non-marring tool

(76) Inventor: Bill Thomas Brazil, Pennington, NJ (US)

Correspondence Address: Bill T. Brazil, 311 West Franklin St., Morrisville, PA, 19067, US

(21) Appl. No.: 10/723,358

(22) Filed: Nov. 26, 2003

Related U.S. Application Data
(60) Provisional application No. 60/435,462, filed on Dec. 20, 2002.
(60) Provisional application No. 60/444,576, filed on Feb. 3, 2003.

(51) Int. Cl. B25B 13/02

(52) U.S. Cl. 81/119

(57) ABSTRACT

The present invention relates to non-marring tools for use in shaping, prying, pulling, levering, tilting, moving, hoisting, fastening, screwing, bolting, wrenching, rotating, revolving, twisting, splitting, ratcheting, chiseling, torqueing, plying, hammering, pounding and the like, wherein the non-marring tools comprise a polymer coating.

This applications claims priority from copending provisional application No. 60/435,462, filed Dec. 20, 2002, the entire disclosure of which is hereby incorporated by reference and copending provisional application No. 60/444,576, filed Feb. 3, 2003, the entire disclosure of which is hereby incorporated by reference.

### FIELD OF THE INVENTION

The present invention generally relates to the fields of handheld tools, pneumatic tools, mechanics and polymers. More particularly, the invention relates to tools for use in prying, pulling, fastening, screwing, bolting, wrenching, rotating, ratcheting, torqueing and the like, wherein the tools comprise a non-marring polymer coating.

### BACKGROUND OF THE INVENTION

Manual and powered tools for prying, pulling, fastening, screwing, bolting, wrenching, rotating, ratcheting and torqueing various materials are known in the mechanical arts. For example, companies such as Snap-On Tools, Inc. (Kenosha, Wis.), Wiha Quality Tools (Monticello, Minn.) and Mac Tools, Inc. (Columbus, Ohio) sell numerous tools (e.g., screwdrivers, sockets, wrenches, pliers, chisels, etc.) for shaping, prying, pulling, plying, levering, tilting, moving, hoisting, fastening, screwing, bolting, wrenching, rotating, revolving, twisting, splitting, ratcheting, chiseling, torqueing, hammering and pounding materials such as wood, metal and plastic.

A common problem encountered when using these tools is marring or disfiguring of the work material or proximal work material. For example, a bolt is a threaded fastener used to secure machine parts by engaging corresponding threads on a nut (or the machine part). The bolt typically has a hexagonal head portion (i.e., the “bolt head”) with 120° corners. Often, when trying to loosen an over torqued hexagonal bolt with a socket wrench, the 120° corners of the bolt “head” become rounded (i.e., marred) such that the head of the socket wrench (also a hexagon having 120° corners) will no longer engage (i.e., fit) the bolt head. The primary cause of the “bolt head rounding” is that the metal composition of the bolt head is softer (or weaker) than the metal composition of the socket head.

A second scenario also occurs when trying to loosen an over torqued hexagonal bolt with a socket wrench. The socket head will disengage (i.e., slip or “break loose”) from the bolt head, wherein the socket and/or the socket wrench will strike the work material and/or proximal work material, thereby marring or damaging the material. The same outcome is observed when loosening or tightening a bolt with an open-end or closed-end wrench, wherein the wrench slips off of the bolt head and mars (or gouges) the proximal work material.

A similar event occurs when loosening or tightening a screw with a screwdriver. The screwdriver (e.g., a flat tip or a Phillips tip) for example, will “slip off” of the screw head (i.e., the work material) and mar (or gouge) the proximal work material. A common source of the screwdriver slipping off or breaking loose from the screw head is the incompatibility of the metal composition of the screwdriver tip relative to that of the screw head (i.e., the work material), and as such, the screwdriver tip often times “strips” the screw head mating surface.

Another example of work material marring occurs when using a pry bar tool, wherein one end of the pry bar is inserted between two objects and the user applies pressure to the opposite handle end of the pry bar tool, using the pry bar tool as a lever and the object(s) as a fulcrum. The composition of pry bar tools (e.g., forged steel, chrome-vanadium steel, etc.) is such that pry bar tool, acting as a lever, often disfigures, damages or mars the much softer surface of the object being levered.

The problem of work material marring is compounded and quite costly when the user of the tool is inexperienced, a “do it yourself” (DIY) mechanic or a home owner making repairs. For example, most internal combustion (IC) engines (e.g., a car engine) develop a cylinder head gasket leak after approximately forty to fifty thousand miles, thereby reducing cylinder compression, fuel economy and overall performance of the engine. The labor cost for replacing a head gasket at an engine repair shop compels many IC engine owners to replace the head gasket on their own. Replacing a cylinder head gasket first requires removal of the carburetor (or fuel injection body), the fuel intake manifold and the valve cover(s). The carburetor is fastened to the fuel intake manifold by hex head or Allen head bolts. The intake manifold and valve cover(s) are also secured to the cylinder head(s) by hex head or Allen head bolts. Once the fuel intake system has been removed, access to the head gasket(s) requires removal of the cylinder head(s), which are tightly secured to the engine block by hex head bolts with torque values of fifty to sixty foot-pounds. Thus, during the process of removing or assembling the above IC engine components, it is highly probable that a work tool (e.g., a socket, a wrench, a screwdriver) slips, “breaks loose” or is dropped, thereby damaging or marring an engine component.

The cost and extent of damage to an object incurred during prying, pulling, fastening, screwing, bolting, wrenching, ratcheting, torqueing, pounding, etc. is partially related to the composition of the work material (or proximal work material). For example, modern IC engine components are made of lightweight (and expensive) aluminum alloy blocks shaped via computer numerically controlled (CNC) machines. These aluminum components are easily marred or damaged when struck or gouged by work tools such as wrenches, sockets, pliers, Allen head wrenches, screwdrivers and the like. In addition, many aluminum and steel engine components comprise a decorative clear coat finish or satin coat finish, which are easily marred or damaged when struck or gouged by work tools such as wrenches, sockets, pliers, Allen head wrenches, screwdrivers and the like

Further, depending on the application, an assortment of work materials are commonly used and are susceptible to work tool damage or marring. For example, nuts, bolts, screws, rivets, cotter pins, mirrors, glasses, plastics, doors, handles, lamps, sinks, engine components, and the like comprise materials such as steel, chrome plated steel, aluminum, copper, magnesium, titanium, carbon fiber, plastics, glasses, woods, and combinations thereof, all of which are materials susceptible to damage, marring, stripping and/or rounding.

Thus, there is a need in the art for effective, non-marring tools for use in shaping, prying, pulling, fastening, screwing, bolting, wrenching, rotating, twisting, torqueing, pounding and the like, wherein the tool reduces or prevents gouging, damaging, marring, disfiguring, stripping, breaking loose and/or rounding of the work material and/or proximal work material when the tool contacts or engages the work material.

### SUMMARY OF THE INVENTION

The present invention is directed to tools used for shaping, prying, pulling, plying, levering, tilting, moving, hoisting, fastening, screwing, bolting, wrenching, rotating, revolving, twisting, splitting, ratcheting, chiseling, torqueing, hammering, pounding and the like, wherein the tool comprises a non-marring polymer coating which prevents gouging, damaging, marring or disfiguring of a work material and/or a proximal work material in the event that the tool contacts the material.

Thus, in certain embodiments, the invention is directed to an open-end wrench comprising (1) a lever body having a first end and a second end and (2) an open-end jaw at one end of the lever body, wherein the open-end jaw comprises (a) an inner jaw surface comprising two or more torque administering surfaces for engaging and torqueing the head of a fastener and (b) an outer jaw surface which does not engage the head of the fastener, wherein the outer jaw surface comprises a polymer coating. In certain embodiments, the lever body comprises an open end jaw at both ends. In another embodiment, the inner jaw surface comprises a polymer coating. In yet other embodiments, the entire surface area of the wrench comprises a polymer coating. In certain other embodiments, the polymer is selected from the group consisting of a polyisocyanate, a polyurethane, a polyester, a polyethylene, an ultra high molecular weight polyethylene (UHMWPE), a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, a polycarbonate/acetonitrile-butadiene-styrene (ABS) alloy, a fluoropolymer, an ionomer resin, a polyamide, a polyimide, a polyamideimide, a vinyl acetate, a co-polymer thereof, a polymer blend thereof or a combination thereof. In one particular embodiment, the inner jaw surface of the open-end wrench consists of two torque administering surfaces in a U-shape. For example, the two torque administering surfaces in a U-shape are parallel to each other and separated from each other by a distance dependent on the length of a third non-torque administering surface. The two torque administering surfaces of a U-shaped open-end wrench are joined to the non-torque administering surface at approximately 90° angles (or slightly radiused 90° angles), wherein the distance between the two torque administering surfaces determines the jaw size of the open end wrench.

In another embodiment, the invention provides a closed-end wrench comprising (1) a lever body having a first end and a second end and (2) a closed-end jaw at one end of the lever body, wherein the closed-end jaw comprises (a) an inner jaw surface comprising a polygonal torque administering surface and (b) an outer jaw surface, wherein the outer jaw surface comprises a polymer coating. In one particular embodiment, the polygonal torque administering surface is a hexagon or a twelve-point star dodecagram. In yet other embodiments, the lever body comprises a closed-end jaw at both ends. In certain other embodiments, the entire surface area of the wrench comprises a polymer coating. In still other embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In yet another embodiment, the invention is directed to a screwdriver comprising (a) a shank having a first end and a second end and (b) a screwdriver head at one end of the shank, wherein the screwdriver head comprises a polymer coating. In one particular embodiment, the shank also comprises a polymer coating. In another embodiment, the screwdriver head is defined as a flat head or a Phillips head. In still another embodiment, the screwdriver head is defined as an Allen head. In yet another embodiment, the screwdriver head is defined as a Torx® head. In certain other embodiments, the shank comprises a screwdriver head at both ends. In another embodiment, one end of the shank comprises a handle for rotating the shank. In yet other embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In certain other embodiments, the invention provides a combination wrench comprising (1) a lever body having a first end and a second end, (2) an open-end jaw at the first end of the lever body, wherein the open-end jaw comprises (a) an inner jaw surface comprising two or more torque administering surfaces and (b) an outer jaw surface comprising a polymer coating and (3) a closed-end jaw at the second end of the lever body, wherein the closed-end jaw comprises (a) an inner jaw surface comprising a polygonal torque administering surface and (b) an outer jaw surface comprising a polymer coating. In one particular embodiment, the inner jaw surface of the open-end jaw consists of two torque administering surfaces in a U-shape. In another particular embodiment, the inner jaw surface of the open-end jaw comprises a polymer coating. In still other embodiments, the polygonal torque administering surface of the closed-end jaw is a hexagon or a twelve-point dodecagram. In one particular embodiment, the inner jaw surface of the closed-end jaw comprises a polymer coating. In yet other embodiments, the entire surface area of the wrench comprises a polymer coating. In other embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In certain other embodiments, the invention is directed to a socket tool comprising (1) a socket body having a longitudinal axis and a first end and a second end transverse thereto, (2) a rectangular or square opening defined by the socket body at the first end for mating with a socket wrench driver head for rotating the socket body about its longitudinal axis and (3) a polygonal receptacle having a plurality of wall segments defined by the socket body at the second end for receiving the polygonal portion of a fastener, wherein the outer surfaces of the socket body comprises a polymer coating. In one particular embodiment, the polygonal receptacle is a hexagon or a twelve-point dodecagram. In certain embodiments, the polygonal receptacle comprises a polymer coating. In another embodiment, the invention provides a socket wrench comprising a polymer coating. In still another embodiment, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In another embodiment the invention is directed to a pry bar comprising a lever, wherein the lever has a first lever end portion, a second lever end portion and a lever body connecting the first and second end portion, wherein at least one lever end portion comprises a polymer coating. In certain embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In yet another embodiment, the invention is directed to a plier comprising (1) a first stationary handle, (2) a second movable handle, the first and second handle being designed and arranged to be movable with respect to one another and to be operable by one hand, (3) a first jaw being connected to the first stationary handle to form a stationary plier portion, (4) a second jaw being connected to the second movable handle to form a movable plier portion and (5) a common joint pivotally connecting the stationary plier portion and the movable plier portion, wherein the first and second jaws comprise a polymer coating. In certain embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In one particular embodiment the invention is directed to a threaded bolt fastener comprising a polygonal head, wherein the polygonal head consists of a polymer coating. In other embodiments, the invention is directed to a threaded nut fastener comprising polygonal outer surface and a threaded helical inner surface for securing a bolt or screw, wherein the outer surface consists of a polymer coating. In still other embodiments, the invention is directed to a threaded screw fastener comprising a Phillips head, a flat head, an Allen head or a Torx® head, wherein the head consists of a polymer coating. In certain embodiments, the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, an ABS alloy, a fluoropolymer, an ionomer resin, a polyamide, a polyimide, a polyamideimide, a vinyl acetate, a co-polymer thereof, a polymer blend thereof or a combination thereof.

In another embodiment the invention provides a kit comprising (1) a threaded bolt fastener comprising a polygonal head, wherein the polygonal head consists of a polymer coating and (2) an open-end wrench comprising a polymer coating. In one particular embodiment, the kit further comprises a threaded nut fastener comprising a polymer coating.

In certain other embodiments, the invention is directed to a kit comprising (1) a threaded bolt fastener comprising a polygonal head, wherein the polygonal head consists of a polymer coating and (2) a closed-end wrench comprising a polymer coating. In one particular embodiment, the kit further comprises a threaded nut fastener comprising a polymer coating.

In yet another embodiment, the invention is directed to a kit comprising (1) a threaded bolt fastener comprising a polygonal head, wherein the polygonal head consists of a polymer coating and (2) a combination wrench comprising a polymer coating. In one particular embodiment, the kit further comprises a threaded nut fastener comprising a polymer coating.

In still other embodiments the invention is directed to a kit comprising (1) a threaded bolt fastener comprising a polygonal head, wherein the polygonal head consists of a polymer coating and (2) a socket comprising a polymer coating. In one particular embodiment, the kit further comprises a threaded nut fastener comprising a polymer coating.

In still another embodiment, the invention provides a kit comprising (1) a threaded screw fastener comprising Phillips head, a flat head, an Allen head or a Torx® head, wherein the head consists of a polymer coating and (2) a screwdriver comprising a polymer coating. In a particular embodiment, the kit further comprises a threaded nut fastener comprising a polymer coating.

Other features and advantages of the invention will be apparent from the following detailed description, from the preferred embodiments thereof, and from the claims of the invention.

### BRIEF DESCRIPTION OF THE DRAWINGS

FIGS. 1A-1E are non-limiting examples of commonly used wrenches. FIG. 1A is a side view of an open-end wrench comprising a lever body 1 and an open-end jaw 2 at both ends of the lever body 1. FIG. 1B is a detailed side view of an open-end wrench jaw 2 of FIG. 1A. The jaw in FIG. 1B comprises an outer jaw surface 3 and an inner jaw 4 comprising three torque administering (or contact) surfaces (indicated by arrows). FIG. 1C is a side view of a closed-end wrench comprising a lever body 2 and a closed-end jaw 1 at both ends of the lever body 2. FIG. 1D is a detailed side view of a closed-end wrench jaw 1 of FIG. 1C. The jaw in FIG. 1D comprises an outer jaw surface 3 and an inner jaw 4 having six torque administering (or contact) surfaces (indicated by arrows). FIG. 1E is a side view of a twelve-point (dodecagram) closed-end wrench jaw. FIG. 1F is a side view of a crow's foot wrench jaw.

FIGS. 2A-2D are non-limiting examples of a flat head screwdriver, a Phillips head screwdriver, a Torx® head drive and an Allen head drive, respectively. FIG. 2A is a flat head screwdriver comprising a shank 1, wherein the shank 1 has a flat tip screwdriver head 2 and a handle 3 at opposite ends of the shank 1. FIG. 2B is an example of a Phillips head screwdriver tip 1. FIG. 2C is a end view of a Torx® head drive tip. FIG. 2D is an end view of an Allen head drive tip.

FIGS. 3A-3C are non-limiting examples of a commonly used socket wrench and socket. FIG. 3A is a side view of a socket wrench comprising a lever body 1 and a socket wrench head 2. The socket wrench head 2 further comprises a socket driver head 3, which engages and rotates the socket shown in FIG. 3B and FIG. 3C. FIG. 3B is a side view of a socket body 1, wherein the socket body 1 has a longitudinal axis comprising a first end 2 and a second end 3 transverse thereto. The first socket end 2 has a rectangular opening which mates with and engages the socket driver head 3 of FIG. 3A. The second socket end 3 has a polygonal receptacle which engages a fastener head. FIG. 3C is an end view of the socket's polygonal receptacle 2, wherein the polygonal receptacle is a hexagon having six torque administering (or contact) surfaces (indicated by arrows) defined by 120° angles. The six sides of the hexagon 2 define the socket's torque administering (or contact) surfaces. The socket's outer surface 1 comprises any portion of the socket not defined by the torque administering surfaces 2 of the polygonal receptacle.

FIG. 4A is a non-limiting example of a threaded fastener. The threaded fastener in FIG. 4A is a hexagonal bolt comprising a head portion 1 having six equal length flat sides 3 joined by 120° corners and a threaded or helical portion 2. The six equal length sides 3 of the bolt head 1 are aligned parallel to the axis of the threaded portion 2 of the fastener. FIG. 4B is a top end view of the hexagonal bolt head of FIG. 4A. The hexagonal bolt head in FIG. 4B has six well defined, equal length, sides joined by 120° corners. FIG. 4C is an example of bolt head rounding, wherein the 120° angles of the bolt head corners observed in FIG. 4B have become marred and rounded off in FIG. 4C.

### DETAILED DESCRIPTION OF THE INVENTION

The present invention addresses a need in the art for non-marring tools which are useful for prying, pulling, fastening, screwing, bolting, wrenching, rotating, ratcheting, torqueing and the like. Currently, tools known and used in the art do not have a means for protecting work material and/or proximal work material when the “working end” of the tool engages or contacts the work material and/or proximal work material. Thus, the invention described hereinafter is directed to various types of tools used for prying, pulling, fastening, screwing, bolting, wrenching, rotating, ratcheting or torqueing a work material, wherein the tool comprises a non-marring polymer coating, wherein the polymer coating reduces or prevents marring or damage of the work material and/or a proximal work material. As defined herein, the terms “mar”, “marring” and “damage” are used interchangeably, and encompass terms such as work material and/or proximal work material scratching, gouging, disfiguration, head rounding, head stripping and the like.

As defined hereinafter, a “tool” or a “work tool” refers to any hand held device, pneumatically operated device, electrically operated device or machine mounted device known and used in the art for accomplishing a particular task. Non-limiting examples of work tools contemplated for use in the present invention are set forth below in Section A.

A “non-marring” tool of the invention comprises a “polymer” (also referred to as a “polymer coating”) at least at the portion of the tool which engages or contacts a work material and/or a proximal work material. The portion of the tool which engages or contacts a work material and/or a proximal work material is also defined hereinafter as the “working end” or “work end” of the tool. As defined hereinafter, the terms “work material” and “proximal work material” refer to any composition of matter, which is distinct and separate from the work tool. The term “work material” particularly refers to a composition of matter in which the tool intentionally engages. In contrast, the term “proximal work material” refers to a nearby composition of matter in which the tool unintentionally, inadvertently or accidentally engages or contacts. For example, when removing a Philips head screw from a carburetor, the screw driver is the “work tool”, the tip of the screw driver is the tool “work end”, the screw head is the “work material” and the carburetor (and other engine components) is the “proximal work material”. Continuing with the above example, when a pry bar is used to lever or pry the carburetor away from the engine's intake manifold, the pry bar is the “work tool”, the lever portion of the pry bar is the “work end”, the carburetor and the intake manifold are the “work materials” and the other engine components are “proximal work material”.

Thus, a work material or a proximal work material comprises, but is not limited to materials such as steel, drop forged steel, nickel forged steel, chrome plated steel, stainless steel, cold or hot rolled steel, aluminum, brass, bronze, zinc, lead, copper, iron, nickel, manganese, molybdenum, silver, chromium, platinum, silicon, magnesium, titanium, carbon fibers, Kevlar® fibers, plastic polymers, glasses, woods and combinations thereof.

A non-marring tool of the invention is used on various work materials and in various applications such as nuts, bolts (e.g., hex head, Allen head, Torx® head), screws (e.g., flat head, Phillips head, Allen head, Torx® head), nails, rivets, cotter pins, washers, mirrors, glasses, plastics, plexi-glasses, doors, handles, hinges, cabinets, shelves, electronic devices, computers, lamps, sinks, engine components, lawn equipment, automotive components, motorcycle components, bicycle components and the like. However, the present invention is not meant to be limited to the above-referenced work materials and/or their applications, as it is contemplated that a work tool comprising a non-marring polymer of the invention reduces or prevents marring of various other work materials known in the art, as long as the tool has a non-marring polymer coating (e.g., see Section C).

A. Non-Marring Tools

In certain embodiments, the invention is directed to a work tool comprising a non-marring polymer coating, wherein the work tool is used for prying, pulling, fastening, screwing, bolting, wrenching, rotating, ratcheting or torqueing a work material. A work tool of the invention therefore comprises a non-marring polymer which “covers” or “coats” at least a portion of the tool which engages or contacts the work material and/or proximal work material. Thus, the polymer coatings of the invention protect a work material and/or a proximal work material from marring or damage resulting from work tool contact, work tool impact, work tool collision, work tool slippage, a dropped work tool, work tool rounding and the like. For a comprehensive review of tool shapes, sizes and/or configurations contemplated for use as “non-marring” tools set forth below, Applicant refers to the Wiha Quality Tools catalogue (Monticello, Minn.) and the Mac Tools catalogue (Columbus, Ohio), each of which are available electronically via the world wide web.

1. Open-End Wrenches

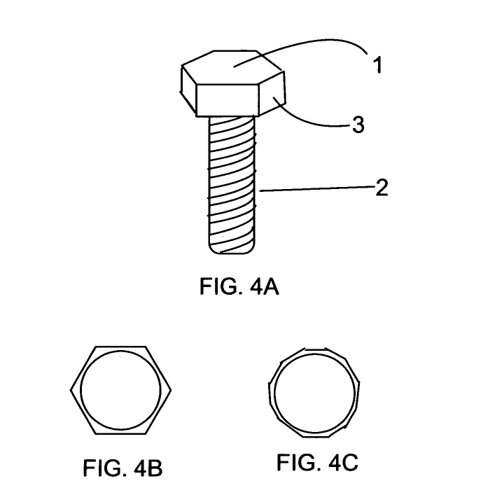

Threaded bolt fasteners are widely used to secure work pieces such as metal parts, wooden parts, glass parts, plastic parts, and combinations thereof, by engaging corresponding threads on a nut or the work piece itself. Bolts are commonly provided with a polygonal head portion having a series of flat surfaces with well defined corners aligned generally parallel to the axis of the threaded portion of the fastener (e.g., see FIG. 4A). The bolt head is usually hexagonal in shape (e.g., six sides of equal length joined by 120° corners), although bolts having square (e.g., four sides joined by 90° corners) or other polygonal shapes are sometimes found. The polygonal head portion (i.e., the bolt head) usually has one of a plurality of standard sizes, measured either in metric or English (i.e., Society of Automotive Engineers, SAE) dimensions, so that the bolt head may be engaged by standard size tools. Fastener “nuts” are also typically polygonal and may also be engaged by certain of these tools. Fastener nuts are well known in the art and any further reference to engaging a fastener head or bolt head will also be understood to include fastener “nuts”.

As defined hereinafter, the term work material “rounding” refers to the undesirable result in which the contact surfaces of the polygonal head portion of a bolt (e.g., a hexagonal head) become marred or damaged such that the appropriate work tool will no longer engage or properly fit the polygonal head portion. For example, when trying to loosen a hexagonal bolt with an open-end wrench, if the 120° corners of the bolt head become “rounded”, the wrench head will no longer engage or properly fit the bolt head (e.g., see FIG. 4C). Work material rounding includes polygonal head portions such as hexagonal bolts or screws, Allen head bolts or screw (e.g., a square head), the star shaped head portion of Torx® head bolts or screws, flat head bolts or screws, Phillips head bolts or screws and the like.

Without wishing to be bound by any particular theory, Applicant contemplates that a primary cause of work material “rounding” is that the polygonal head portion is typically a softer (or weaker) composition than the metal composition of the work tool. Aluminum and nylon fasteners, which often are used to reduce the overall weight of an assembled part, are non-limiting examples of work materials that are easily rounded by a work tool. Work tools generally comprise steel, drop forged steel, nickel forged steel, chrome plated steel, stainless steel and the like, as these materials are extremely durable and withstand the forces needed to torque various fasteners. Thus, a work tool comprising a polymer coating on its polygonal contact surface(s) will reduce the “hardness” of the work tool contact surfaces and concomitantly reduce work material rounding. In certain embodiments, a work tool of the invention therefore comprises a polymer coating on its contact surface(s), wherein the polymer prevents or reduces work material rounding.

As defined hereinafter, the term work tool “slippage” refers to an event in which a work tool's contact surface(s) “slips”, “loses its grip” or “breaks free” from the polygonal head portion of a hexagonal bolt or screw, an Allen head bolt or screw, a Torx® head bolt or screw, a flat-head bolt or screw, a Phillips head bolt or screw and the like. Work tool slippage often results in an unwanted impact or collision between the work tool and a proximal work material, thereby marring or damaging the proximal work material. Thus, a work tool comprising a polymer coating on its polygonal contact surface(s) improves the grip between the contact surface(s) of the work tool and the polygonal head portion of a work material, thereby reducing the probability of proximal work material damage or marring.

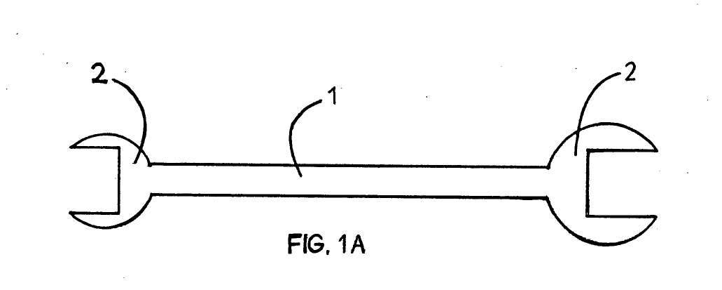

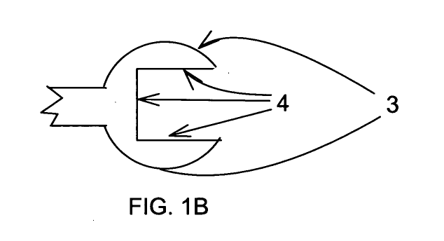

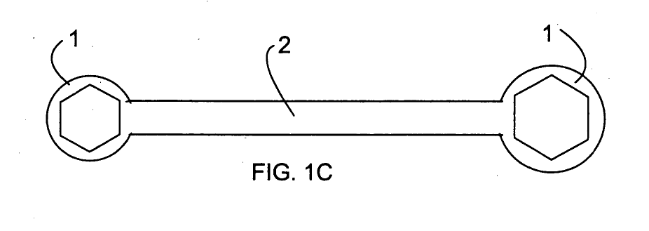

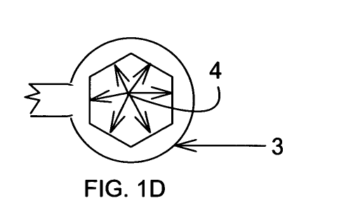

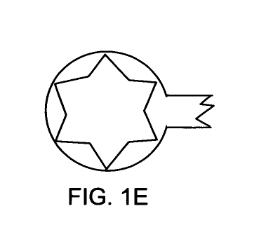

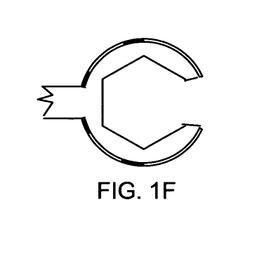

Thus, in certain embodiments, the invention is directed to an open-end wrench comprising a non-marring polymer coating. Open-end wrenches are used and well known in the art (e.g., see U.S. Pat. Nos. 6,334,374, 4,130,032, 4,058,032, each specifically incorporated herein by reference). In general, an open-end wrench is applied either axially or radially to a torque receiving (or contact) surface of a work material (e.g., a bolt head). The “torque administering surface” of a wrench has defined sides and corners (e.g., see FIG. 1B, FIG. 1D, FIG. 1E and FIG. 1F) which are complementary to the torque receiving surface of a work material such as hexagonal nut or a bolt head (FIG. 4B).

As defined hereinafter, an “open-end wrench” comprises (1) about two to about five contact surfaces, referred to as a “jaw” or “inner jaw surface”, which allows the wrench to engage a torque receiving surface such as a bolt head or nut from the side and (2) a torque lever body (or handle) having a first end portion and a second end portion, wherein a jaw is attached at one end of the lever body or at both ends of the lever body (e.g., see FIGS. 1A and 1B). The jaw(s) of an open-end wrench may be “adjustable” (e.g., an adjustable open-end wrench as described in U.S. Pat. No. 4,048,876, specifically incorporated herein by reference) or “non-adjustable”, such as a wrench having a specific metric or SAE fractional jaw size designation.

Thus, the working end of an open-end wrench comprises a jaw, wherein the jaw comprises an “inner jaw surface” and an “outer jaw surface”. As defined hereinafter, the “inner jaw surface” of an open-end wrench comprises the work material (e.g., bolt head or nut) “contact” or “engaging” surface(s), also referred to hereinafter as the “torque administering” surface(s) (e.g., see FIG. 1B). As defined hereinafter, an. “outer jaw surface” of an open-end wrench refers to any portion of the jaw not defined as a torque administering surface. Stated another way, an outer jaw surface of a work tool is the portion of the jaw which does not directly engage or contact the torque receiving surface of a work material such as a bolt head or a nut.

Thus, in a particular embodiment of the invention, a non-marring open-end wrench comprises at least a polymer coating on the outer jaw surface, wherein the polymer coating protects a proximal work material from marring or damage resulting from work tool contact, work tool impact, work tool collision, a dropped work tool, etc. In certain other embodiments, an open-end wrench further comprises a polymer coating on the inner jaw surface (i.e., the torque administering surface), wherein the polymer coating on the inner jaw surface reduces or prevents work material rounding and/or work tool slippage. In still other embodiments, the wrench further comprises a polymer coating on the torque lever body (i.e., the wrench handle).

The open end wrench described above typically comprises an open-end jaw at both ends of the lever body, wherein the jaws are different sizes. Alternatively, an open-end wrench of the invention is a wrench known in the art as a combination wrench. A combination wrench comprises an open-end jaw at one end of the lever body and a closed-end jaw (described below) at the other end of the lever body, wherein the jaws are the same size or different sizes.

A non-marring open-end wrench of the invention includes open-end wrench configurations such as (1) 10°, 25° or 60° offset wrenches, (2) half moon wrenches, (3) S-shape wrenches, (4) T-handle wrenches, (5) L-handle wrenches, (6) crow's foot wrenches, (7) flare nut wrenches, (8) four-way angle head wrenches, (9) crescent wrenches and (10) combinations thereof, all of which are well known in the art.

2. Closed-End Wrenches

In another embodiment, the invention is directed to a closed-end (also known as a box-end) wrench comprising a non-marring polymer coating. In contrast to an open-end wrench, a closed-end wrench does not engage a work material (e.g., a bolt head) from the side or radially. Examples of various wrench configurations such as a closed-end wrench, an adjustable closed-end wrench and a ratcheting closed-end wrench are found in U.S. Pat. Nos. 6,435,063, 6,240,814, 5,865,074 and 4,744,271, each specifically incorporated herein by reference. Thus, a non-marring closed-end wrench of the invention includes various types of closed-end wrenches known or used in the art, such as ratcheting and/or adjustable closed-end wrenches.

As defined hereinafter, a “closed-end wrench” comprises: (1) an enclosed torque administering surface (i.e., an enclosed inner jaw), wherein the closed-end wrench torque administering surface (or jaw) must engage a work material (e.g., a bolt head) axially and (2) a torque lever body (or handle) having a first end portion and a second end portion, wherein the jaw is attached at one end portion of the lever body or at both end portions of the lever body (e.g., see FIG. 1C).

Thus, in one embodiment of the invention, a non-marring closed-end wrench comprises at least a polymer coating on the outer jaw surface, wherein the polymer coating protects a proximal work material from marring or damage resulting from work tool contact, work tool impact, work tool collision, a dropped work tool, etc. In certain other embodiments, a closed-end wrench further comprises a polymer coating on the inner jaw (torque administering) surface, wherein the polymer coating on the inner jaw surface reduces or prevents work material rounding and/or work tool slippage. In still other embodiments, the closed-end wrench further comprises a polymer coating on the torque lever body (i.e., the wrench handle).

A non-marring closed-end (or box end) wrench of the invention includes closed-end wrench configurations such as (1) 10°, 25° or 60° offset wrenches, (2) half moon wrenches, (3) S-shape wrenches, (4) ratcheting wrenches, (5) T-handle wrenches, (6) L-handle wrenches, (7) flare nut wrenches, (8) hex head wrenches, (9) twelve-point head wrenches and (10) combinations thereof, all of which are well known in the art.

3. Sockets and Socket Wrenches

In yet another embodiment, the invention is directed to a socket and/or a socket wrench comprising a non-marring polymer coating. Conventional sockets and socket wrenches are well known and used in the art. “Non-conventional” socket and socket wrench styles are also well known in the art. For example, U.S. Pat. No. 5,123,310, specifically incorporated herein by reference, describes a socket for turning fastener heads having deformed surfaces. U.S. Pat. No. 6,138,534, specifically incorporated herein by reference, describes a universal socket designed for a socket wrench. U.S. Pat. No. 6,009,777, specifically incorporated herein by reference, describes a ratcheting socket wrench and U.S. Pat. No. 6,006,634, specifically incorporated herein by reference, describes a socket wrench with an impact drive useful for freeing “stubborn” fasteners.

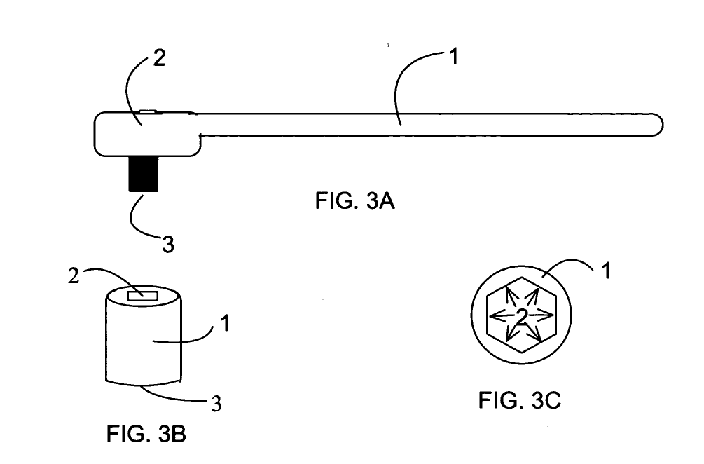

A socket for turning a fastener head (e.g., a bolt head) generally has a body portion made of a durable material such as hardened steel within which a polygonal receptacle (e.g., a hexagon or a 12-point dodecagram) is defined. The polygonal receptacle of the socket has a size appropriate to fit a corresponding standard size fastener head. As defined hereinafter, a “socket” is used to engage a polygonal head portion of a threaded fastener (i.e., a torque receiving surface such as a hexagonal bolt head having six 120° corners) and transfers torque from a socket wrench to the fastener, to turn the fastener. A “socket” is further defined as comprising (1) a socket body having a longitudinal axis and (a) first and (b) second ends transverse thereto, (2) a rectangular opening defined by the socket body at the first end for mating with a socket wrench driver head for rotating the socket body about its longitudinal axis and (3) a polygonal receptacle (i.e., torque administering surfaces) having a plurality of wall segments defined by the socket body at the second end for receiving the polygonal portion of a fastener (e.g., see FIG. 3A-3C). A non-marring socket of the invention includes sockets commonly know in the art as hex head sockets, twelve-point head sockets, Torx® head sockets (or “star” driver sockets) and Allen head sockets.

Thus, in certain embodiments of the invention, a non-marring socket comprises at least a polymer coating on the outer surface of the socket (i.e., the non-torque administering surface) which protects a proximal work material from marring or damage resulting from work tool contact, work tool impact, work tool collision, a dropped work tool, etc. In other embodiments, a non-marring socket comprises a polymer coating on the polygonal receptacle surface of the socket (i.e., the torque administering surface), wherein the polymer coating on the torque administering surface reduces or prevents work material rounding and/or work tool slippage. In another embodiment, the entire surface area of the socket comprises a polymer coating. In yet other embodiments, the socket wrench (or wrench handle) comprises a polymer coating.

4. Screwdrivers

In certain embodiments, the invention is directed to a screwdriver comprising a polymer coating. Screwdrivers are well known and described in the art. For example, U.S. Pat. Nos. 5,749,272, 4,762,036 and 4,328,721, each specifically incorporated herein by reference, describe a ratchet screwdriver, a multi bit screwdriver and a Phillips screwdriver with a retractable slotted screw driver blade. As defined hereinafter, a “screwdriver” refers to any tool or apparatus commonly known and referred to in the art as a screwdriver. For example, screwdrivers are known and used in the art to engage a screw (or bolt), twist a screw, tighten a screw or loosen a screw.

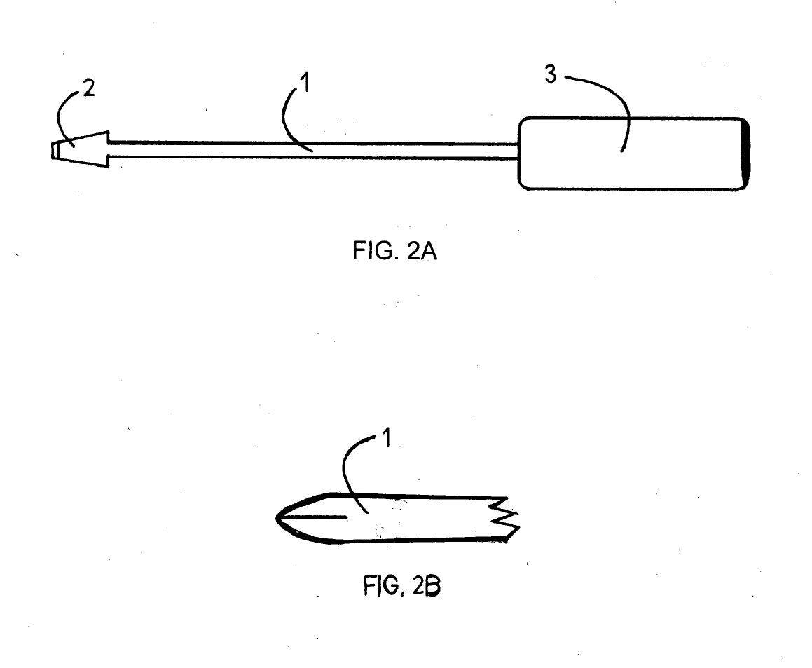

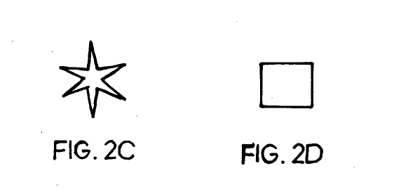

A non-marring screwdriver of the invention therefore comprises a shank having a first end and a second end, wherein a longitudinal handle is optionally located at the first end of the shank and the second end of the shank comprises a screwdriver tip or head (e.g., a flat head, a Phillips head, an Allen head, a Torx® head) for engaging a screw (e.g., see FIG. 2A-FIG. 2D). As defined herein, a “screw” has (1) a slotted (or flat) head, a Phillips head, an Allen head, a Torx® head, or any other type of head, which is engaged by a screwdriver and (2) a helical groove along the screw body (or shank). A non-marring screwdriver of the invention further includes screw fastening tools commonly known in the art as T-handle drivers such as T-handle Torx® head drivers (or “star” head drivers), metric (or SAE) T-handle Allen head drivers, also known as T-handle Allen wrenches, L-shaped Torx® head drivers and L-shaped Allen head drivers, also known as L-shaped Allen wrenches.

Thus, in particular embodiments, a non-marring screwdriver comprises a polymer coating at the screwdriver head (or tip), wherein the polymer coating reduces or prevents proximal work material marring or damage resulting from work tool contact, work tool slippage, work tool impact, work tool collision, work tool rounding, work tool gouging, a dropped work tool, etc. In addition, a screwdriver comprising a polymer coating at the screwdriver tip or head reduces stripping of the screw “head”, thereby reducing or preventing work tool slippage as described in Section A.1. As defined hereinafter, a “stripped screw head” is one which no longer engages properly with a screwdriver, and as such will not readily turn under the torqueing forces of the screwdriver. The terms “stripping of a screw head”, a “stripped screw head” or a “stripped head” include any screw head which is engaged by a screwdriver defined supra.

In certain other embodiments, the entire surface area of the screwdriver shank, including the tip (or head), comprises a polymer coating. In still other embodiments, the entire screwdriver (i.e., the handle, shank and tip) comprises a polymer coating.

5. Pry Bars

In another embodiment, the invention is directed to a non-marring pry bar comprising a polymer coating. Pry bars are well known and used in the art (e.g., see U.S. Pat. Nos. 6,471,186 and 6,308,934, each specifically incorporated herein by reference). Typically, a pry bar comprises a lever, wherein the lever has a first lever end portion, a second lever end portion and a lever body connecting the first and second end portion. The first and second lever end portions are the same shape and size, or alternatively are different shapes and/or sizes.

Thus, in particular embodiments, a non-marring pry bar comprises at least a polymer coating at one lever end of the pry bar, wherein the polymer coating protects a work material from marring or damage resulting from work tool contact, work tool impact, work tool collision, work tool slippage, work tool rounding, a dropped work tool, etc. In certain other embodiments, the entire surface area of the pry bar comprises a polymer coating.

6. Pliers

In yet another embodiment, the invention is directed to a non-marring plier comprising a polymer coating. Pliers are well-known and described in the art. For example, various types of pliers can be found in U.S. Pat. Nos. 6,477,925, 6,474,130, 6,467,380 and 6,408,725, each specifically incorporated herein by reference. Typically, a plier comprises (1) a first stationary handle, (2) a second movable handle, the first and second handle being designed and arranged to be movable with respect to one another and to be operable by one hand, (3) a first jaw being connected to the first stationary handle to form a stationary plier portion, (4) a second jaw being connected to the second movable handle to form a movable plier portion and (5) a common joint pivotally connecting the stationary plier portion and the movable plier portion. A non-marring plier of the invention therefore includes pliers commonly known in the art as bent or straight needle nose (or long nose) pliers, cutting pliers (e.g., diagonal cutters), wire stripping pliers, retaining ring pliers, tongue and groove pliers, pipe wrench pliers, slip-joint pliers, Lineman's pliers, vice grip pliers and the like.

Thus, in particular embodiments, a non-marring plier comprises at least a polymer coating on the outer jaw surface of the plier, wherein the polymer coating protects a proximal work material from marring or damage resulting from work tool contact, work tool impact, work tool rounding, work tool collision, work tool slippage, a dropped work tool, etc.

The jaw size of pliers are typically adjustable, in contrast to the fixed jaw sizes of conventional open-end wrenches, closed-end wrenches or sockets. A common problem encountered when using a plier having an adjustable jaw size (e.g., in contrast to a non-adjustable SAE closed-end wrench) is that the contact surface(s) of a work material are more readily marred or damaged. Thus, in certain embodiments of the invention, the inner jaw surface(s) of the plier comprise a polymer coating, thereby reducing or preventing damage or marring of a work material contact surface. In yet other embodiments, the entire surface area of the plier comprises a polymer coating.

7. Piston Ring Compressors

In certain embodiments, the invention is directed to a piston ring compressor comprising a polymer coating. The introduction of a piston assembly into a cylinder bore of a combustion engine is a complex and awkward process. In order to accomplish this task, piston rings must be compressed around grooves of the piston while the entire piston assembly (including the connecting rod) is properly oriented and positioned with respect to the cylinder bore of the engine block. This process is further complicated by the fact that an operator or technician must apply a substantial amount of compression about the piston rings while at the same time installing the piston assembly into the cylinder bore of the engine block.

Many piston ring compressors are currently known and commercially used throughout the industry (e.g., see U.S. Pat. Nos. 6,427,301, 6,389,667 and 5,765,272, each specifically incorporated herein by reference in its entirety). For example, one type of piston ring compressor includes a piston ring clamp having two ring halves connected together at one end by a hinge joint and at opposite ends by a screw device. The ring halves are pivoted into an open position and are positioned around the piston rings, and are then moved to a closed position for clamping and compressing the piston rings. The entire piston assembly is then pushed through the clamp into the cylinder of the engine block. An adjustable member such as, for example, a ratchet mechanism, is provided between the separable ends of the ring halves to adjust an inside diameter of the piston ring compressor. This prevents the ring halves from engaging the outer surface of the piston, thus ensuring that the piston assembly can be pushed out of the clamp and into the cylinder of the engine block.

However, most piston ring compressors do not apply uniform compressive forces around the circumference of the piston rings, and cause a greater compressive force on portions of the piston ring than remaining portions of the piston ring. This non-uniform compressive force not only damages the piston rings but also hinders the ability of the piston assembly to slide through the clamp into the cylinder, thereby marring the piston. In addition, even when a piston ring compressor does in fact apply a uniform compressive force around the circumference of the piston rings, the operator must be careful not to over tighten the compressor around the piston rings. For example, if the ring compressor is too tight of a fit around the piston (and its piston rings), the piston is not readily pushed out of the clamp and into the cylinder of the engine block, which thereby results in piston marring and/or piston ring damage.

Thus, in certain embodiments, the invention is directed to a piston ring compressor comprising a polymer coating, wherein the polymer coating protects the piston and piston rings from being scratched, marred or damaged. Without wishing to be bound by any particular theory, it is contemplated in certain embodiments, that the polymer coating reduces the friction between the piston/piston rings and the piston ring compressor, thereby reducing piston/piston ring binding in the compressor, which facilitates the transfer of the piston from the compressor into the cylinder. Thus, in certain embodiments, the piston ring compressor comprises a polymer coating on the portion of the compressor (e.g., the inner surface of the compressor) which clamps the piston rings. In other embodiments, the entire surface area of the piston ring compressor comprises a polymer coating.

B. Non-Marring Fasteners

In certain embodiments, the invention is directed to fastener type work materials, wherein the fastener consists of a non-marring polymer on its head portion (i.e., torque receiving surfaces), wherein the fastener does not comprise a polymer on its threaded or helical portion. In other embodiments, the invention is directed to a kit comprising one or more non-marring fasteners, a non-marring tool of the invention, and optionally one or more non-marring fastener nuts.

Threaded fasteners are widely used work materials to secure work pieces by engaging corresponding threads on the work piece itself or a nut fastener. Bolt type fasteners commonly comprises a polygonal head portion having a series of flat (torque receiving) surfaces with well defined corners. The torque receiving surfaces are aligned generally parallel to the axis of the threaded portion of the fastener (e.g., see FIG. 4A). The bolt head is usually hexagonal, also referred to as a hex head (e.g., six sides of equal length joined by 120° corners; see FIG. 4B), rectangular, or square, also referred to as an Allen head (e.g., four sides joined by 90° corners). The polygonal head portion usually has one of a plurality of standard sizes, measured either in metric or English (i.e., Society of Automotive Engineers, SAE) dimensions, so that the polygonal head may be engaged by standard size tools. Threaded fasteners of the invention include screw type fasteners known in the art as flat head screws, Phillips head screws, Allen head screws, Torx® head screws and the like.

Thus, a non-marring fastener of the invention comprises a fastener head portion (i.e., torque receiving surface) which is engaged by an open-end wrench, a closed-end wrench, a combination wrench, a socket, a crescent wrench, a plier, an Allen wrench, a Torx® wrench, a flat head screwdriver, a Phillips head screwdriver, a Torx® head screw driver, an Allen head screwdriver and the like. In a particular embodiments, a non-marring fastener head torque receiving surface consists of a thermoplastic, an elastomer, a thermoplastic elastomer or a thermoset polymer described in Section C.

As stated supra, “rounding” (e.g., see FIG. 4C) refers to the undesirable result in which the contact (or torque receiving) surfaces of the polygonal head portion of a fastener become marred or damaged such that the appropriate work tool will no longer engage or properly fit the polygonal head portion. It is contemplated herein that a threaded fastener comprising a non-marring polymer of the invention reduces or prevents “rounding” of the fastener head potion, particularly when a non-marring fastener of the invention is torqued with a non-marring tool of the invention.

C. The Non-Marring Polymer

It is known in the art, that a common occurrence in the processes of shaping, prying, pulling, levering, tilting, moving, hoisting, fastening, screwing, bolting, wrenching, rotating, revolving, twisting, splitting, ratcheting, chiseling, torqueing, plying, hammering, pounding and the like, is a marring of the work material and/or a proximal work material. To reduce or prevent proximal work material marring, it is desirable that a polymer coating function as a “protective” barrier between work tool and the proximal work material, thereby reducing the damaging or marring effects of work tool contact, impact, collision, slippage, and the like. Similarly, to reduce or prevent work material marring such as head rounding, head stripping and/or work tool slippage, it is desirable that a polymer coating: (1) function as a “protective” barrier between work tool and the work material and/or (2) function to reduce the hardness of the work tool torque administering or contact surface(s) (e.g., the inner jaw surface of a wrench) and/or (3) function to increase adhesion between the torque receiving surface of the work material and the torque administering or contact surface(s) of the work tool.

In certain embodiments, a piston ring compressor comprises a polymer coating. In one particular embodiment, the inner surface of the piston ring compressor comprises a polymer coating. In certain other embodiments, the inner surface of the piston ring compressor comprises a polymer coating which has a low coefficient of friction. As defined hereinafter, the “inner surface” of a piston ring compressor is the portion of compressor which contacts, clamps or holds the piston rings and the piston. In still other embodiments, the entire surface area of the piston ring compressor comprises a polymer coating.

Thus, the present invention provides non-marring tools comprising a polymer coating as described supra in Sections A.1-A.7, such that the polymer coating reduces or prevents marring, damaging or disfiguring of a work material and/or a proximal work material in the event of work tool contact, impact, collision, slippage, head rounding, head stripping, a dropped tool and the like. Similarly, a non-marring fastener of the invention consists of a polymer coating on its torque receiving surfaces (i.e., head portion) as described in Section B supra.

Polymers are often classified as either biological polymers or industrial polymers. Biological polymers consist of polymers such as polysaccharides, deoxyribonucleic acids (DNA), polypeptides, lipids and the like. Industrial polymers are typically grouped into five classes: (1) “plastics” (thermoplastics and thermosets), (2) “elastomers” (natural and synthetics rubbers), (3) “man-made fibers”, (4) “adhesives” and (5) “surface coatings”. More recently a sixth industrial polymer class, known as (6) “thermoplastic elastomers”, has been added.

Thus, a non-marring polymer of the invention is generally an industrial polymer. More specifically, a non-marring polymer of the invention comprises a plastic, an elastomer, a thermoplastic elastomer, a plastic blended or formulated with a man-made fiber, an elastomer blended or formulated with a man made fiber, a thermoplastic elastomer blended or formulated with a man made fiber and combinations thereof. The properties of plastics, elastomers, thermoplastic elastomers and fibers are set forth below.

“Adhesives” are generally defined as any substance that is capable of holding materials together in a functional manner by surface attachment that resists separation. Adhesive as a general term includes cement, mucilage, glue and paste, terms that are often used interchangeably for any organic material that forms an adhesive bond.

“Man-made fibers” are spun and woven into a huge number industrial products. The polymers from which man-made fibers are produced are characterized by long, chainlike molecules of great size and molecular weight. Many man-made fibers comprise the same, or similar compounds that make up plastics. In certain embodiments, it is contemplated that man-made fibers are added to a plastic, elastomer or thermoplastic elastomer formulation to modulate one or more mechanical properties of a polymer of the invention.

A “surface coating” is any mixture of film-forming materials which, when applied to a surface and cured or dried, yields a functional and durable thin film (i.e., a coating). Most surface coatings employed in industry are based on synthetic polymers, and as such, the terms “surface coating” and “plastic” will often overlap. As defined hereinafter, the term “surface coating” is interchangeable with the terms “plastic”, “plastic polymer” or “plastic coating”, as long as the “surface coating” is formulated with a plastic or has functional properties of a “plastic”.

In certain embodiments, a polymer of the invention is a plastic. Plastic polymers are well known in the art and have the capability of being molded or shaped, usually by application of heat and/or pressure. Plastics are most often defined on the basis of their behavior. More specifically, plastics are defined hereinafter as either “thermoplastic” resins or “thermosetting” resins. Thermoplastics (e.g., polyethylene and polystyrene) are capable of being molded and remolded repeatedly. The polymer structure associated with thermoplastics is that of individual molecules that are separate from one another and flow past one another. Thermoplastic molecules have molecular weights (M_{w}) ranging from low to extremely high, and they are branched or linear in structure, but the common feature is that of separability and consequent mobility. Thermosets, in contrast, cannot be reprocessed upon reheating. During their initial processing, thermosetting resins (e.g., epoxies and phenolics) undergo a chemical reaction that results in an infusible, insoluble network. Essentially, the entire heated, finished thermoset article becomes one large molecule (i.e., a network polymer or cross-linked polymer).

The plastic behavior of polymers is also influenced by their morphology, or arrangement of molecules on a macro scale. Plastic polymer morphologies are either amorphous or crystalline. Amorphous molecules are arranged randomly and are intertwined, whereas crystalline molecules are closely packed and in a discernible order. Most thermosets are amorphous, while thermoplastics are amorphous or semicrystalline. Semicrystalline materials display crystalline regions, called crystallites, within an amorphous matrix.

By definition, thermoplastic materials retain their molded shapes up to a certain temperature, which is set by the glass transition temperature (T_{g}) or the melting temperature (Tₘ) of the particular polymer. For example, below the T_{g} the molecules of a polymer material are frozen in what is known as the glassy state, wherein there is little or no movement of molecules past one another, and the material is stiff. Above the T_{g}, the amorphous parts of the polymer enter the rubbery state, in which the molecules display increased mobility and the material becomes plastic and/or rubbery. In the case of noncrystalline polymers such as polystyrene, raising the temperature further leads directly to the liquid state. On the other hand, for partly crystalline polymers such as low-density polyethylene or polyethylene terephthalate, the liquid state is not reached until the melting temperature (Tₘ) is passed. Beyond this point the crystalline regions are no longer stable, and the liquid polymers are molded or extruded. For example, in high-density polyethylene, the long sequences of ethylene units that make up the polymer spontaneously crystallize at temperatures below about 265° F., so that, at normal temperatures (e.g., about 68° F.) polyethylene is a partially crystalline plastic solid. Polypropylene crystallites (or crystallized regions) do not melt until they are heated to about 350° F. Thermosets, which do not melt upon reheating, are dimensionally stable up to a temperature at which chemical degradation begins. Listed in the first and second rows of Table 3-A through Table 3-D are the Tₘ and/or T_{g} of various plastics.

In certain embodiments of the invention, a non-marring threaded fastener described supra in Section B comprises a plastic polymer, particularly when the non-marring fastener is to be used in high heat applications such as securing parts of an engine, a computer component, an electrical device such as a toaster and the like.

In certain other embodiments, a polymer of the invention is an elastomer. In contrast to plastic polymers, an “elastomeric polymer” (or “elastomer”) is defined hereinafter as a rubbery material composed of long, chainlike molecules that are capable of recovering their original shape after being stretched to great extents. Under normal (relaxed) conditions, the long molecules making up an elastomeric material are irregularly coiled. However, with the application of force the molecules straighten out in the direction in which they are being pulled. Upon release, the molecules spontaneously return to their normal compact, random arrangement.

Thus, elastomers are highly flexible, whereas plastic polymers are rather stiff and inflexible. Table 3-A through Table 3-D list the physical and mechanical properties of several plastics (i.e., thermoplastics and thermosets). Similarly, Table 3-E through Table 3-F list the physical and mechanical properties of several rubbers (i.e., elastomers).

Four common elastomers are cis-polyisoprene (natural rubber), cis-polybutadiene (butadiene rubber), styrene-butadiene rubber and ethylene-propylene monomer. The elastomeric polymers of cis-polyisoprene and cis-polybutadiene have a Tₘ of about 75° F. and 40° F., respectively. In addition, the T_{g} of all these polymers are quite low, well below 68° F. (i.e., room temperature), so that all of them are soft, highly flexible, and elastic. Other elastomers well known in the polymer arts include acrylic rubber (alkyl acrylate copolymer), butyl rubber (isobutylene-isoprene copolymer), epichlorhydrin, hydrogenated nitrile rubber, isoprene rubber (synthetic cis-polyisoprene), nitrile rubber (acrylonitrile-butadiene copolymer) and silicone rubber.

In addition to their Tₘ and/or T_{g}, plastic and elastomeric polymers are often differentiated by hardness. The hardness testing of polymers is most commonly measured by the Shore or Rockwell hardness test. Both methods measure the resistance of plastics toward indentation and provide an empirical hardness value. Shore Hardness, using either the Shore A or Shore D scale, is the preferred method for rubbers/elastomers and is also commonly used for “softer” plastics. The Shore A scale is used for “softer” rubbers while the Shore D scale is used for “harder” ones. The Rockwell R scale is most commonly used for “hard” plastics. The high end of the Shore A scale overlaps with the low end of the Shore D scale (Table 1), so as to provide an approximate continuity between the two scales.

TABLE 1
SHORE A AND SHORE D HARDNESS EQUIVALENCY CHART
100A ≅ 75D
95A ≅ 50D
90A ≅ 40D
85A ≅ 32D

Listed below in Table 2 is a relative comparison of the hardness values of various elastomer and plastic polymers.

TABLE 2
Comparison of Shore A, Shore D and Rockwell R Hardness Scales

| ELASTOMER/ | HARDNESS SCALE | | | |
|---|---|---|---|---|
| RUBBER | SHORE | SHORE | ROCKWELL | PLASTIC |
| POLYMERS | A | D | R | POLYMERS |
| | | | 150 | Phenolic |
| | | | 140 | |
| | | | 130 | Polymethylmethacrylate |
| | | | | (Acrylic) |
| | | | 120 | Polycarbonate/ABS alloy |
| | | | 110 | Polymethacrylate Butadiene |
| | | | | Styrene; PVC |
| | | 80 | 100 | Nylon |
| | | | 95 | |
| | 100 | | 90 | Polystyrene |
| | | 70 | 85 | Polypropylene |
| | | | 80 | |
| | | | 75 | High Density Polyethylene |
| | | | 70 | |
| | | 60 | 65 | Tetrafluoroethylene (Teflon ® ) |
| | | | 60 | Thermoplastic Polyurethane |
| | | | 55 | Ultra High M_{w} Polyethylene |
| | 95 | 50 | 50 | Low Density Polyethylene |
| | | | 40 | Polybutylene; Ionomers |
| | 90 | 40 | | |
| | 85 | 30 | | |
| Styrene-Butadiene | | | | |
| Tire Tread Rubber | 70 | | | |
| Butyl Rubber | 60 | | | |
| Polyisoprene (Rubber) | | | | |
| Nitrile Rubber | 50 | | | |
| Methylphenyl Silicone Rubber | | | | |
| Ethylene Propylene Rubber | 40 | | | |
| | 30 | | | |
| Rubber Bands | | | | |
| Polychloroprene (Neoprene) | 20 | | | |

TABLE 3-A
PHYSICAL PROPERTIES OF PLASTICS AND RUBBERS
Thermoplastics

| Physical | | Polyamide- | Low Density | Ultra High M_{w} | Polycarbonate | |
|---|---|---|---|---|---|---|
| Properties | Polybutylene | Imide | Polyethylene | Polyethylene | ABS Alloy | Polypropylene |
| Melting Temp. | 255° F. | ND | 230° F. | 280° F. | 482° F. | 350° F. |
| (Tm) | | | | | | |
| Glass Transition | ND | 527° F. | −40° F. | ND | ND | −4° F. |
| Temp. (Tg) | | | | | | |
| Elongation % | 350 | 5 | 515 | 15 | 100 | 200 |
| Tensile Strength | 5000 psi | 18000 psi | 1943 psi | 5800 psi | 750 psi | 4500 psi |
| Dynamic | ND | 0.30 | ND | 0.12 | ND | ND |
| Coefficient of | | | | | | |
| Friction | | | | | | |
| Static Coefficient | ND | ND | ND | 0.20 | ND | ND |
| of Friction | | | | | | |
| Rockwell | R40 | R120 | ND | R55 | R116 | R95 |
| Hardness | | | | | | |
| Shore D Hardness | ND | D90 | D55 | D67 | ND | ND |
| Shore A Hardness | ND | ND | ND | ND | ND | ND |

ND = Not Determined
Dynamic and Static Coefficient of Friction measured against steel.

TABLE 3-B
PHYSICAL PROPERTIES OF PLASTICS AND RUBBERS
Thermoplastics

| | | Polymethyl- | | | | |
|---|---|---|---|---|---|---|
| | Polymethyl- | Methacrylate | | | | Polyvinylidene |
| | Methacrylate | Butadiene | Polyvinyl | Polyamide | Thermoplastic | Fluoride |
| Physical Properties | (Acrylic) | Styrene | Chloride (PVC) | (Nylon 6,6) | Polyurethane | (PVDF) |
| Melting Temp. | 160° F. | ND | 520° F. | 505° F. | 284° F. | 310° F. |
| (Tm) | | | | | | |
| Glass Transition | 212° F. | 212° F. | 180° F. | 125° F. | ND | −40° F. |
| Temp. (Tg) | | | | | | |
| Elongation % | 48 | 20 | 7.5 | 150 | 500 | ND |
| Tensile Strength | 7000 psi | 7200 psi | 8700 | 7600 psi | 5800 psi | 8700 psi |
| Dynamic | ND | ND | 0.39 | ND | ND | ND |
| Coefficient of | | | | | | |
| Friction | | | | | | |
| Static Coefficient of | 0.40 | ND | 0.34 | ND | ND | ND |
| Friction | | | | | | |
| Rockwell Hardness | R120 | R110 | R110 | R110 | R60 | R110 |
| Shore D Hardness | ND | ND | ND | ND | ND | D80 |
| Shore A Hardness | ND | ND | ND | ND | ND | ND |

ND = Not Determined
Dynamic and Static Coefficient of Friction measured against steel.

TABLE 3-C
PHYSICAL PROPERTIES OF PLASTICS AND RUBBERS
Thermoplastics

| | | | | | Polyester-semi- | |
|---|---|---|---|---|---|---|
| | Acetal | Polyether- | Polyphenyl | | crystalline | |
| Physical | homopolymer/ | etherketone | Sulfone | Polyether | thermoplastic | Polybenzimidazole |
| Properties | PTFE-filled | (PEEK) | (PPS) | Imide (PEI) | (PET) | (PBI) |
| Melting Temp. | 350° F. | 644 | ND | ND | 491° F. | ND |
| (Tm) | | | | | | |
| Glass Transition | ND | ND | 428° F. | 420° F. | ND | 750° F. |
| Temp. (Tg) | | | | | | |
| Elongation % | 15 | 10 | 30 | 80 | 20 | 3 |
| Tensile Strength | 8000 psi | 15000 psi | 1100 psi | 16500 psi | 12400 psi | 20000 psi |
| Dynamic | 0.19 | 0.40 | ND | 0.42 | 0.20 | 0.24 |
| Coefficient of | | | | | | |
| Friction | | | | | | |
| Static Coefficient | ND | ND | ND | ND | ND | ND |
| of Friction | | | | | | |
| Rockwell R | R115 | R126 | R120 | R125 | R125 | ND |
| Hardness | | | | | | |
| Shore D Hardness | D83 | D85 | D80 | D86 | D87 | D94 |
| Shore A Hardness | ND | ND | ND | ND | ND | ND |

ND = Not Determined
Dynamic and Static Coefficient of Friction measured against steel.

TABLE 3-D
PHYSICAL PROPERTIES OF PLASTICS AND RUBBERS

| Thermoplastics | | | | |
|---|---|---|---|---|
| | | Tetrafluoroethylene | | |
| | | perfluoromethylvinyl | | Ionomers |
| | Polytetrafluoroethylene | ether copolymer | Polymethylmethacrylate/ | Ethylene/Methacrylic |
| Physical Properties | (Teflon ® ) | (PFA) | PVC alloy (Kydex ® ) | Acid (Surlyn ® ) |
| Melting Temp. | 620° F. | 572° F. | ND | 195° F. |
| (Tm) | | | | |
| Glass Transition | 260° F. | 10° F. | 195° F. | ND |
| Temp. (Tg) | | | | |
| Elongation % | 200 | ND | ND | 400 |
| Tensile Strength | 4060 psi | 4205 psi | 58000 psi | 4000 psi |
| Dynamic* | ND | 0.09 | ND | ND |
| Coefficient of | | | | |
| Friction | | | | |
| Static* Coefficient | 0.05 | 0.10 | ND | ND |
| of Friction | | | | |
| Rockwell Hardness | ND | ND | R105 | R40 |
| Shore D Hardness | D50-65 | D60 | ND | ND |
| Shore A Hardness | ND | ND | ND | ND |

ND = Not Determined
Dynamic and Static Coefficient of Friction measured against steel.

TABLE 3-E
PHYSICAL PROPERTIES OF PLASTICS AND RUBBERS
Elastomers (Rubbers)

| | | | | Poly(butyl 2- | |
|---|---|---|---|---|---|
| | Polyisoprene | Polybutadiene | Ethylene- | propenoate) | Styrene- |
| | (Natural | (Butadiene | propylene-diene | (PolybutylAcrylate | Butadiene |
| Physical Properties | Rubber) | Rubber) | (EPDM) Rubber | Rubber) | copolymer |
| Melting Temp. | 95° F. | 35° F. | ND | 117° F. | ND |
| (Tm) | | | | | |
| Glass Transition | −103° F. | −148° F. | ND | −45° F. | −67° F. |
| Temp. (Tg) | | | | | |
| Elongation % | 650-900 | ND | 500 | ND | 600 |
| Tensile Strength | 725 psi | ND | 1450 psi | ND | 2175 psi |
| Dynamic | ND | ND | 3.10 | ND | ND |
| Coefficient of | | | | | |
| Friction | | | | | |
| Static Coefficient of | ND | ND | ND | ND | 1.5-2.0 |
| Friction | | | | | |
| Rockwell-R | ND | ND | ND | ND | ND |
| Hardness | | | | | |
| Shore D Hardness | ND | ND | ND | ND | ND |
| Shore A Hardness | A55 | ND | 48 | ND | A40-90 |

ND = Not Determined
Dynamic and Static Coefficient of Friction measured against steel.

TABLE 3-F
PHYSICAL PROPERTIES OF PLASTICS AND RUBBERS
Elastomers (Rubbers)

| | | | Acrylonitrile- | | |
|---|---|---|---|---|---|
| | Ethylene | Polyisobutylene- | Butadiene | | Methylphenyl |
| | Propylene | co-isoprene (Butyl | copolymer | Polychloroprene | Silicone |
| Physical Properties | Rubber | Rubber) | (Nitrile Rubber) | (e.g., Neoprene ®) | rubber |
| Melting Temp. | ND | 35° F. | ND | 85° F. | −108° F. |
| (Tm) | | | | | |
| Glass Transition | −75° F. | −96° F. | −40° F. | −10° F. | −170° F. |
| Temp. (Tg) | | | | | |
| Elongation % | 600 | 850 | 650 | 4000 | ND |
| Tensile Strength | 3000 psi | 2610 psi | 3000 psi | 715 psi | 870 psi |
| Dynamic | ND | ND | ND | 2.20 | ND |
| Coefficient of | | | | | |
| Friction | | | | | |
| Static Coefficient of | ND | ND | ND | ND | ND |
| Friction | | | | | |
| Rockwell-R | ND | ND | ND | ND | ND |
| Hardness | | | | | |
| Shore D Hardness | ND | ND | ND | ND¹ | ND |
| Shore A Hardness | A35-90 | A40-60 | A50-90 | A15-90 | A50 |

ND = Not Determined
ND¹ = When polymerized at 131° F. required 2 months for hardening.
Dynamic and Static Coefficient of Friction measured against steel.

In certain embodiments, a polymer of the invention is a thermoplastic elastomer. One example of thermoplastic elastomers are molecules containing a few hydrogen-bonding groups. If the associations between the molecules (i.e., the hydrogen bonds) are strong enough to prevent flow under moderate stresses, such materials are rubbery or elastic solids. Also, because the weak interlinks of hydrogen bonds give way at high temperatures, the elastomer material to takes on a new shape in response to pressure and as such, they can be reprocessed and reused. Another example of a thermoplastic elastomer is generally made by blending a specific elastomer with a specific thermoplastic material. For example, Santoprene® is a thermoplastic elastomer which consists of a mixture of approximately 60 parts ethylene-propylene-diene monomer copolymer (EPDM) with 40 parts polypropylene. Because the two polymers are molecularly incompatible, they form a fine, heterogeneous blend, the individual materials remaining as small, separate regions. During mixing, the EPDM portion becomes chemically interlinked to create a rubbery solid that can be molded (and remolded) at high temperatures, when the polypropylene component becomes soft and fluid.

Thus, a non-marring tool of the invention comprises a thermoplastic polymer, an elastomer, a thermoplastic elastomer and the like. In certain preferred embodiments, a polymer of the invention comprises, but is not limited to, one or more of the following polymers (or polymer starting materials): a polyisocyanate, a polyurethane, a polyester, a polyethylene, an ultra high molecular weight polyethylene (UHMWPE), a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, a polycarbonate/acetonitrile-butadiene-styrene (ABS) alloy, a fluoropolymer, an ionomer resin, a polyamide, a polyimide, a polyamideimide, a vinyl acetate, a co-polymer thereof, a polymer blend thereof or any combination thereof.

The following non-limiting list of polymers are divided into (1) carbon-carbon chain polymers (also called vinyls) and (2) heterochain polymers (also called non-vinyls). As defined herein, a “homopolymer” is a polymer made out of a single monomer species. A “copolymer” is a polymer made from more than one kind of monomer, that is, made out of two or more comonomers In contrast, a “polymer alloy” or “polymer blend” is a polymer mixture made by combining two or more polymer resins. A “block copolymer” is a copolymer in which the comonomers are separated into long sections of the polymer backbone chain.

1. Carbon-Carbon Chain Polymers (Vinyl Polymers)

In carbon-chain polymers, as the name implies, the backbones are composed of linkages between carbon atoms. The carbon-carbon chain polymers are also referred to as vinyls, as they typically contain the hydrocarbon vinyl group (CH₂═CH—).

a. Polyolefins

A large portion of industrial plastic polymers are polymerized olefins (polyolefins). Olefins are hydrocarbons whose molecules contain a pair of carbon atoms linked together by a double bond. Polyolefins include, but are not limited to, ethylene, propylene, and butylene. Olefin molecules are commonly represented by the chemical formula CH₂═CHR, with the R group representing an atom or pendant molecular group of varying composition. The composition and structure of the R group determines which of the huge array of possible properties will be demonstrated by the polymer.

i. Polyethylenes

Ethylene, commonly produced by the cracking of ethane gas, forms the basis for the largest single class of plastics, the polyethylenes. An ethylene monomer has the chemical composition CH₂═CH₂; as the repeating unit of polyethylene. Polyethylene is produced in linear or branched forms. Branched versions are known as low-density polyethylene (LDPE) or linear low-density polyethylene (LLDPE); the linear versions are known as high-density polyethylene (HDPE) and ultrahigh molecular weight polyethylene (UHMWPE).

HDPE a linear polymer, which allows the polymer chains to pack closely together, resulting in a dense, highly crystalline material of high strength and moderate stiffness. Uses include blow-molded bottles for milk and household cleaners and injection-molded pails, bottle caps, appliance housings, and toys.

UHMWPE is made with molecular weights of three million to six million atomic units, as opposed to 500,000 atomic units for HDPE. These polymers can be spun into fibers and drawn, or stretched, into a highly crystalline state, resulting in high stiffness and a tensile strength many times that of steel.

Thus, in certain embodiments of the invention, a non-marring plastic is a polyethylene. In one embodiment, a polyethylene is a UHMWPE such as UHMWPEs known as Tivar® and Tivar® DrySlide (Poly Hi Solidur, Inc., Fort Wayne, Ind.). In other embodiments, a polyethylene is a HPDE, for example, a HPDE known as Sanalite® (Poly Hi Solidur, Inc., Fort Wayne, Ind.).

In another embodiment of the invention, a non-marring plastic is a polyethylene blend. For example, U.S. Pat. No. 4,007,298, incorporated herein by reference, sets forth blends of HDPE and LDPE exhibiting “tenacious adhesion” to ferrous metals. U.S. Pat. No. 6,596,815, incorporated herein by reference, describes thermoplastic blends of ionomer/HDPE with improved flow characteristics (i.e., reduced viscosity), without significantly degrading physical properties such as impact resistance and tensile strength.

ii. Polypropylenes

Polypropylene is a highly crystalline thermoplastic resin, built up by the chain-growth polymerization of propylene (CH₂═CHCH₃). Polypropylene shares some of the properties of polyethylene, but it is stiffer and has a higher Tₘ. As a plastic, polypropylene is blow-molded into bottles for foods, shampoos, and other household liquids. It is also injection-molded into many products, such as appliance housings, dishwasher-proof food containers, toys, automobile battery casings, and outdoor furniture. When a thin section of molded polypropylene is flexed repeatedly, a molecular structure is formed that is capable of withstanding much additional flexing without failing. This fatigue resistance has led to the design of polypropylene boxes and other containers with self-hinged covers.

In certain embodiments, a non-marring plastic of the invention is a polypropylene. In certain embodiments, the polypropylene is propylene homopolymer.

iii. Polystyrenes

Polystyrene is a rigid, relatively brittle thermoplastic resin, polymerized from styrene (CH₂═CHC₆H₅). Styrene, also known as phenylethylene, is obtained by reacting ethylene with benzene in the presence of aluminum chloride to yield ethylbenzene, which is then dehydrogenated to yield clear, liquid styrene.

The presence of the pendant phenyl (C₆H₅) group is key to the properties of polystyrene. The phenyl groups prevent the polymer chains from packing into a close, crystalline arrangement, so that solid polystyrene is transparent. In addition, the phenyl rings restrict rotation of the chains around the carbon-carbon bonds, thus lending the polymer its noted rigidity.

Foamed polystyrene is made into insulation, packaging, and food containers such as beverage cups, egg cartons, and disposable plates and trays. Solid polystyrene products include injection-molded eating utensils, audiocassette holders, and cases for packaging compact discs. More than half of all polystyrene produced is blended with five to ten percent polybutadiene to reduce brittleness and improve impact strength. This blend is marketed as high-impact polystyrene.

iv. Polyvinyl Chloride (PVC)

Second only to polyethylene in production and consumption, PVC is manufactured by bulk, solution, suspension, and emulsion polymerization of vinyl chloride monomer (CH₂═CHCl), using free-radical initiators. Pure PVC is rigid and has low flammability PVC is often blended with a plasticizer (sometimes in concentrations as high as fifty percent) to reduce its rigidity.

Thus, in certain embodiments of the invention, a non-marring plastic polymer is a PVC, for example, a type 1, grade 1 PCV. In certain other embodiments, a non-marring plastic is a PVC/acrylic blend. U.S. Pat. No. 4,113,681, incorporated herein by reference, describes a thermoplastic powder comprising a blend of a vinyl chloride/vinyl acetate/maleic acid terpolymer, an acrylic polymer and an ester plasticizer; wherein the thermoplastic powder is useful as a finish for metals such as tubing, wires, fence posts, lawn furniture, play equipment and the like.

v. Polyvinylidene Chloride (PVDC)

Vinylidene chloride (CH₂═CCl)₂, is made directly from ethylene and chlorine or by the further chlorination of vinyl chloride with subsequent removal of hydrogen chloride by alkali treatment. It is polymerized in suspension or emulsion processes, using free-radical initiators. In certain embodiments of the invention, a non-marring plastic formulation comprises a PVDC.

vi. Polyvinyl Acetate (PVAC)

The monomer vinyl acetate (CH₂═CHO₂CCH₃) is prepared from ethylene by reaction with oxygen and acetic acid over a palladium catalyst and is polymerized with free-radical initiators. In certain embodiments of the invention, a non-marring plastic formulation comprises a PVAc, a blend thereof or a co-polymer thereof.

b. Acrylics

Acrylates are a family of polymers made from acrylate monomers, wherein the acrylate monomers are esters which contain vinyl groups. Some acrylates have an extra methyl group attached to the alpha carbon, and these are called methacrylates. One of the most common methacrylate polymers is poly(methyl methacrylate). Poly(methyl acrylate) is a white rubber at room temperature, whereas poly(methyl methacrylate) is a strong, hard, and clear plastic at room temperature.

Poly(acrylic acid) is a polyelectrolyte, such that each repeat unit has an ionizable carboxylic acid group. There are several derivatives of polyacrylates which contain nitrogen, e.g., polyacrylamide and polyacrylonitrile. Polyacrylonitrile is used to make acrylic fibers.

Thus, in certain embodiments, a non-marring plastic of the invention is an acrylic or a polyacrylic. For example, U.S. Pat. No. 6,146,473, incorporated herein by reference, describes an acrylic resin for coating a metal surface, wherein the resin has improved corrosion resistance, adhesion and slip properties (i.e., “lubricity”).

i. Polymethyl Methacrylate (PMMA)

Methyl methacrylate is polymerized in bulk or suspension methods using free-radical initiators. The presence of a pendant methyl (CH₃) group prevents the polymer chains from packing closely in a crystalline fashion and from rotating freely around the carbon-carbon bonds. As a result, PMMA is a transparent and rigid plastic; often used as a substitute for glass. PMMA is also employed in domed skylights, swimming pool enclosures, aircraft canopies, instrument panels, and luminous ceilings. For these applications the plastic is sold in the form of sheets that are machined or thermoformed, but it is also injection-molded into headlights and taillights and lighting-fixture covers. In certain embodiments of the invention a non-marring plastic is PMMA.

ii. Polyacrylate Elastomers

Acrylic esters, copolymerized with small amounts (approximately five percent) of another monomer containing a reactive halogen, can form polymer chains that inter link at the halogen sites. These so-called polyacrylate elastomers display good heat resistance (almost as good as silicone rubbers and fluoroelastomers) and resistance to swelling by hydrocarbon oils. They are mainly used for O-rings, seals, and gaskets. In one embodiment of the invention, a polyacrylate elastomer is blended or formulated with one or more additional polymers, such that the final polymer composition physically and/or mechanically performs as a plastic.

c. Fluorinated Polymers (Fluoropolymers)

In other embodiments, a non-mar polymer of the invention is a fluoropolymer (e.g., a fluoropolymer sold under the name Teflon®; DuPont® Wilmington, Del.), particularly a polytetrafluoroethylene (PTFE), a perfluoroalkoxy (PFA), a fluorinated ethylene propylene (FEP), an ethylene tetrafluoroethylene (ETFE) or a blend of one or more of a PTFE, a PFA, a FEP and a ETFE. Fluoropolymers are inert to virtually all chemicals, are extremely durable, are abrasion resistant and are considered the most slippery (lubricous) material in existence. For example, U.S. Pat. Nos. 5,168,107, 4,596,839, 4,049,863 and 4,087,394, each incorporated herein by reference, describe fluoropolymer formulations and coating metal objects with such formulations, wherein the coated object has “improved” scratch resistance and lubricious characteristics.

Teflon® PTFE is a nonstick two-coat (primer/topcoat) system. PTFE coatings have the highest operating temperature of any fluoropolymer (550° F.), an extremely low coefficient of friction, good abrasion resistance and good chemical resistance. Teflon® FEP is a low friction nonstick coating providing excellent chemical resistance. Teflon®) PFA, having similar properties to FEP, offers the additional benefits of higher continuous use temperature (500° F.), film thicknesses up to 1,000 micrometers and greater toughness than PTFE or FEP. This combination of properties makes PFA an excellent choice for a wide variety of uses, especially those involving chemical resistance. Teflon® ETFE, also sold under the Tefzel® trademark, is the toughest of the fluoropolymers and can be applied at film builds up to 1,000 micrometers to provide a highly durable finish. Thus, fluoropolymer coatings such as PTFE, PFA, FEP and ETFE, set forth above, are particularly well suited as non-marring tool coatings of the invention. In certain embodiments, the inner surface of a piston ring compressor comprises a PTFE, a PFA, a FEP or a ETFE coating.

In certain other embodiments, a fluoropolymer is a polyvinyl fluoride (PVF) or a polyvinylidene fluoride (PVDF) (see Example 3). PVF is frequently extruded into transparent film and often applied as a laminate protective layer onto outdoor surfaces. PVDF is made into injection-molded objects and extruded films. In one embodiment of the invention, a non-marring plastic is a PVDF or a modified PVDF such as PVDF2-Plus™ (Continental Industries, Inc.; Tualatin, Oreg.). U.S. Pat. No. 4,557,977, incorporated herein by reference, sets for a thermoplastic PVDF/acrylic blend used to coat steel and aluminum components, wherein the plastic coating exhibits excellent steel and aluminum adhesion.

d. Vinyl Copolymers

Vinyl copolymers Include most of the synthetic elastomers not described below under diene polymers (See Section 1.e), along with several specialty plastics and thermoplastic elastomers.

i. Acrylonitrile-Butadiene-Styrene (ABS)

ABS is a graft copolymer made by dissolving styrene-butadiene copolymer in a mixture of acrylonitrile and styrene monomers, then polymerizing the monomers with free-radical initiators in an emulsion process. ABS is a tough, heat-resistant thermoplastic. The three structural units provide a balance of properties, the butadiene groups (predominantly trans-1,4) imparting good impact strength, the acrylonitrile affording heat resistance and the styrene units giving rigidity. ABS is widely used for appliance and telephone housings, luggage, sporting helmets, pipe fittings, and automotive parts. Thus, in certain embodiments of the invention, a non-marring plastic is an ABS or a blend thereof (e.g., ABS blended with SAN).

ii. Styrene-Acrylonitrile (SAN)

Styrene and acrylonitrile, in a ratio of approximately seventy:thirty, are copolymerized under emulsion, bulk, or solution conditions using free-radical initiators. The copolymer is a rigid, transparent plastic that displays better resistance to heat and solvents than does polystyrene alone. Much of the SAN produced is blended with ABS. Principal uses are in automotive parts, battery cases, kitchenware, appliances, furniture, and medical supplies.

iii. Styrene-Butadiene and Styrene-Isoprene Block Copolymers

These “tri-block” copolymers, also known as styrene-butadiene-styrene (SBS) and styrene-isoprene-styrene (SIS), consist of polystyrene sequences (or blocks) at each end of the chain and a butadiene or isoprene sequence in the center. Polystyrene end-blocks of adjacent chains collect together in small “domains,” so that clusters of polystyrene are distributed through a network of butadiene or isoprene. Such a structure makes SBS and SIS into thermoplastic elastomers, blends that exhibit the elasticity and resilience of polybutadiene or polyisoprene along with the permanence of the fixed ends. Like all thermoplastic elastomers, SBS and SIS are less resilient than permanently inter-linked molecular solids, and they do not recover as efficiently from deformation. Also, they soften and flow as the glass transition temperature of polystyrene (about 212° F.) is approached, and they are completely dissolved (and not merely softened) by suitable liquids. Nevertheless, SBS and SIS are easily processed and reprocessed, owing to the thermoplastic properties of polystyrene, and they are remarkably strong at room temperature. They are frequently used for injection-molded parts and as hot-melt adhesives (especially in shoes). In certain embodiments of the invention, a non-marring plastic is a SBS or a SIS.

iv. Ethylene-Propylene Copolymers

There are two major types of ethylene-propylene copolymers with elastomeric properties: those made with the two monomers alone and those made with small amounts (approximately five percent) of a diene, usually ethylidene norbornene or 1,4-hexadiene. Both copolymers are prepared in solution, the former are known as EPM (ethylene-propylene monomer) and the latter as EPDM (ethylene-propylene-diene monomer). The copolymers contain approximately sixty percent by weight ethylene. A pronounced advantage of EPDM is that the residual carbon-carbon double bond (i.e., the double bond that remains after polymerization) is attached to the polymer chain rather than being made part of it. Carbon-carbon double bonds are quite reactive. For example, ozone in the atmosphere adds quickly to a double bond to form an unstable product that spontaneously decomposes. Regular diene polymers, such as natural rubber or styrene-butadiene rubber, have many double bonds in the main chain, so that, when one double bond is attacked, the entire molecule is broken. EPDM, with the double bonds located in the side groups, is much less susceptible to degradation by weathering and sunlight, because any breaking of the double bonds by ozonolysis, thermal deterioration, or oxidation leaves the main chains intact. In addition, some crystallinity appears to be induced by stretching, so that even without fillers, vulcanized ethylene-propylene copolymers are quite strong. However, like other hydrocarbon elastomers, the ethylene-propylene copolymers are swollen and weakened by hydrocarbon oils. The principal uses of EPM are in automobile parts and as an impact modifier for polypropylene. EPDM is employed in flexible seals for automobiles, wire and cable insulation, weather stripping, tire sidewalls, hoses; and roofing film.

EPDM is also mixed with polypropylene to make a thermoplastic elastomer. These polymer blends, which usually contain thirty to forty mole percent polypropylene, are rubbery solids, though they are not nearly as springy and elastic as covalently interlinked elastomers. However, owing to the thermoplastic properties of polypropylene, they can be processed and reprocessed, and they are resistant to oxidation, ozone attack, and weathering. They are therefore used in such low-severity applications as shoes, flexible covers, and sealing strips. The trademarked product Santoprene, produced by Advanced Elastomer Systems, L.P., is an example. Some block copolymers of ethylene and propylene, called polyallomers, are marketed. Unlike EPM and EPDM, which have a relatively amorphous morphology, the polyallomers are crystalline and exhibit properties of high-impact plastics.

v. Plastisols

In certain embodiments, a non-marring polymer of the invention is a plastisol. Plastisols are made from one or more polyvinyl chloride (PVC), vinyl chloride-vinyl acetate copolymers, polyvinylidene chloride, vinylidene chloride copolymers, lower polyethylene oxides, etc. U.S. Pat. No. 4,151,317, incorporated herein by reference, describes plastisol compositions and methods thereof for coating metallic materials. Plastisols are commonly used to coat metal picnic benches, metal park benches, metal trash cans, barbecue grills, and the like. For example, QCM Industrial (Kent, Wash.) markets various plastisol formulations for dip coating metal. Depending on the formulation, a plastisol can be altered to produce a variety of different physical properties such as chemical resistance and abrasion resistance.

vi. Polyacrylic/PVC Alloys

In another embodiment, a non-mar plastic of the invention is a polyacrylic/PVC alloy. In one embodiment, the polyacrylic/PVC alloy is Kydex® (Kleerdex Company; Aiken, S.C.). Kydex® is available as a resin for extrusion or injection molding or as 0.028 inch to 0.50 inch sheets suitable for thermoforming, laminating or machining. Kydex® compounds are available in various grades and most typically have a notched Izod impact resistance up to 18 foot pounds/inch (953 J/m). U.S. Pat. No. 5,992,957, incorporated herein by reference, sets forth a method for eliminating abrasion/friction between sliding parts by thermoform coating the parts with Kydex®.

e. Diene Polymers (RUBBERS)

Dienes are compounds whose molecules contain two carbon-carbon double bonds separated by a single bond. The most important diene polymers are (polybutadiene, polychloroprene and polyisoprene) elastomers that are made into vulcanized rubber products.

i. Polybutadiene (Butadiene Rubber)

Butadiene (CH₂═CH—CH═CH₂) is produced by the dehydrogenation of butene or butane or by the cracking of petroleum distillates. It is polymerized to polybutadiene by solution methods. Like the other diene polymers, polybutadiene is isomeric and can thus be produced with more than one molecular structure. A common elastomeric structure is cis-1,4 polybutadiene. Polybutadienes are made either with high cis content (95 to 97 percent) or with only 35 percent cis content along with 55 percent trans and 10 percent “side vinyl.” The properties of the two polymers are quite different. Although both display much higher resilience than other elastomers, the resilience of the mixed-isomer polymer is somewhat lower. In addition, the mixed polymer never crystallizes, so that, without reinforcing fillers such as carbon black, its products are weak and brittle. Much of the polybutadiene produced is blended with natural rubber (polyisoprene) or with styrene-butadiene rubber to give improved resilience and lower rolling resistance. More than half of all usage is in tires; other applications are footwear, wire and cable insulation, and conveyor belt.

ii. Polychloroprene (Chloroprene Rubber)

Polychloroprene is the polymer name for the synthetic rubber known as neoprene. Neoprene is a good general-purpose rubber, but it is limited to special-properties applications because of its high cost. Of the several structures adopted by the chloroprene repeating unit, the most common is trans-1,4 polychloroprene. This polymer tends to crystallize and harden slowly at temperatures below about 50° F. It also crystallizes on stretching, so that cured components are strong even without fillers. Because the double bond between the carbon atoms is shielded by the pendant atoms and CH₂ groups, the molecular inter-linking necessary for producing a cured rubber is usually effected through the chlorine atom. The presence of chlorine in the molecular structure causes this elastomer to resist swelling by hydrocarbon oils, to have greater resistance to oxidation and ozone attack, and to possess a measure of flame resistance.

iii. Polyisoprene

Of the several isomeric forms that polyisoprene can adopt, natural rubber consists almost exclusively of the cis-1,4 polymer. Natural rubber is extensible and tough, as evidenced by its ability to be stretched repeatedly to seven or eight times its original length. The polymer chains crystallize readily on stretching, lending greater strength, so that natural rubber is a self-reinforcing material. In its natural state, however, rubber is greatly affected by temperature: it crystallizes on cooling, taking only several hours to do so at −13° F. and it becomes tacky and inelastic above approximately 120° F. In addition, like other diene elastomers, it is swollen and weakened by hydrocarbon oils, and it reacts with oxygen and ozone in the atmosphere, leading to rupture of the polymer molecules and softening of the material over time. These disadvantages are overcome to a great extent by the vulcanizing and compounding processes.

2. Heterochain Polymers (Non-Vinyls)

A wide variety of heterochain polymers (ie., polymers in which the backbone contains elements such as oxygen, nitrogen, sulfur, or silicon in addition to carbon) are contemplated for use as non-marring polymers of the invention. Representatives of each heterochain polymer family are described below.

a. Aldehyde Condensation Polymers

Aldehyde condensation polymers are compounds produced by the reaction of formaldehyde with phenol, urea or melamine as set forth below.

i. Phenol-Formaldehyde Polymers

Phenol-formaldehyde polymers, also known as phenolic resins, were the first completely synthetic polymers to be commercialized. Two methods are used to make phenol-formaldehyde polymers. In one, an excess of formaldehyde is reacted with phenol in the presence of a base catalyst in water solution to yield the resole, which is a low-molecular-weight pre-polymer with CH₂OH groups attached to the phenol rings. On heating, the resole condenses further, with loss of water and formaldehyde, to yield thermosetting network polymers. The other method involves reacting formaldehyde with an excess of phenol using an acid catalyst to produce pre-polymers called novolacs. Novolacs resemble the polymer except that they are of much lower molecular weight and are still thermoplastic. Curing to network polymer is accomplished by the addition of more formaldehyde or, more commonly, of compounds that decompose to formaldehyde on heating. Phenolic resins, invariably reinforced with fibers or flakes, are also molded into heat-resistant objects such as electrical connectors and appliance handles.

ii. Urea-Formaldehyde Polymers

Resins made from urea-formaldehyde polymers are processed in much the same way as resoles (i.e., using excess formaldehyde). Urea-formaldehyde polymers are also used to treat textile fibers in order to improve wrinkle and shrink resistance, and they are blended with alkyd paints in order to improve the surface hardness of the coating.

iii. Melamine-Formaldehyde Polymers

Melamine formaldehyde polymers are similar to urea-formaldehyde resins in their processing and applications. In addition, their greater hardness and water resistance makes them suitable for decorative dinnerware and for fabrication into the tabletop and countertop product developed by the Formica Corporation and sold under the name Formica®. Melamine-based polymers are also extensively employed as cross-linking agents in baked surface-coating systems. As such, they have had many industrial applications, for instance, in automobile topcoats and in finishes for appliances and metal furniture.

b. Polyamides

A polyamide is a polymer that contains repeating amide groups (R—CO—NH—R′) as integral parts of the main polymer chain. Synthetic polyamides are produced by a condensation reaction between monomers, in which the linkage of the molecules occurs through the formation of the amide groups. They may be produced by the interaction of a diamine (two amine (NH₂) groups) and a dicarboxylic acid (two carboxyl (CO—OH), or they may be formed by the self-condensation of an amino acid or an amino-acid derivative. The most important of the amide polymers are nylons and aramids (also known as aromatic nylons or aromatic polyamides).

Poly(meta-phenylene) isophthalamide is an aromatic polyamide sold under the name Nomex® (DuPont®, Wilmington, Del.). The amide groups in Nomex® are separated by meta-phenylene groups, that is, the amide groups are attached to the phenyl ring at the 1 and 3 carbon positions. Nomex® and similar aramids are generally dry-spun from the solution in which the polymer is prepared. Poly(para-phenylene) terephthalamide is an aromatic polyamide sold under the trade name Kevlar® (DuPont®, Wilmington, Del.). Because of the rodlike structure of the para-oriented aramids, a “liquid-crystalline” solution is obtained that pre-orients the molecules even before they are spun, leading to as-spun fibers of ultrahigh strength and ultrahigh stiffness. Kevlar® polymers are wet-spun from a hot, high-solids solution of concentrated sulfuric acid.

Kevtar® has a unique and highly oriented structure which creates fibers with (1) extremely high tensile strength, six times stronger than steel on a pound for pound bases, (2) improved flexural strength and (3) excellent impact/chip resistance. Kevlar® and similar aramids are employed in belts for radial tires, cables, reinforced composites for aircraft panels and boat hulls, flame-resistant garments (especially in blends with Nomex®), sports equipment such as golf club shafts and lightweight bicycles, and as asbestos replacements in clutches and brakes.

Thus, in certain embodiments of the invention, a non-marring plastic comprises Kevlar®. In other embodiments of the invention, a non-marring plastic comprises Nomex®. In still other embodiments, a non-marring plastic comprises a blend of Kevlar® and Nomex®.

In certain embodiments, a non-marring plastic of the invention comprises a nylon (e.g., nylon 6, nylon 6,6, nylon 11, nylon 12). Nylon coatings are known for their highly durable and low frictional properties. U.S. Pat. No. 3,932,340, incorporated herein by reference, describes a nylon coating having excellent abrasive resistance and adhesive strength to the object (substrate) coated. For example, the object to be coated is dipped into a nylon containing solution (e.g., nylon 6, nylon 6,6, nylon 12) and then heated to remove the solvent, thereby forming the nylon coating film. U.S. Pat. No. 2,193,529, incorporated herein by reference, describes nylon 6 and nylon 6,6 resins, and blends thereof. Example 2 of the invention describes a lever coated with nylon 12 via a fluidized bed.

C. Polyesters

Polyesters are polymers made by a condensation reaction taking place between monomers in which the linkage between the molecules occurs through the formation of ester groups. The esters, which in almost all cases link an organic alcohol to a carboxylic acid, have the general structure R—COO—R′, where R and R′ are any organic combining groups. The major industrial polyesters include polyethylene terephthalate, polycarbonate, degradable polyesters, alkyds, and unsaturated polyesters.

In certain embodiments, a non-marring plastic of the invention comprises a polyester, a co-polymer thereof or a blend thereof. U.S. Pat. No. 4,304,883, incorporated herein by reference, describes an unsaturated polyester resin used to coat metal surfaces, wherein the polyester resin comprises an unsaturated alkyd component and a polymerizable vinyl monomer. U.S. Pat. No. 5,470,912, incorporated herein by reference, describes a polyester resin composition having enhanced flexibility and impact resistance. In certain embodiments, the polyester coating is applied to a tool via powder coating.

i. Polyethylene Terephthalate (PET)

PET is produced by the step-growth polymerization of ethylene glycol and terephthalic acid. The presence of the large benzene rings in the repeating units gives the polymer notable stiffness and strength, especially when the polymer chains are aligned with one another in an orderly arrangement by drawing (i.e., stretching) in this semi-crystalline form, PET is made into a high-strength textile fiber marketed under such trademarked names as Dacron® (DuPont®, Wilmington, Del.). The stiffness of PET fibers makes them highly resistant to deformation, so that they impart excellent resistance to wrinkling in fabrics.

At a slightly higher molecular weight PET is made into a high-strength plastic that can be shaped by all the common methods employed with other thermoplastics. Recording tape and magnetic film is produced by extrusion of PET film (often sold as Mylar® and Melinex®). Molten PET can be blow-molded into a transparent container of high strength and rigidity that also possesses good impermeability to gas and liquid. In this form PET has become widely used in carbonated-beverage bottles and in jars for food processed at low temperatures. It is the most widely recycled plastic. Thus, in certain embodiments of the invention, a non-marring plastic comprises a PET. U.S. Pat. No. 6,046,264, incorporated herein by reference, describes a general formulation for making thermoplastic PET suitable for injection molding.

ii. Polybutylene Terephthalate (PBT)

PBT, a strong and highly crystalline engineering plastic, is similar in structure to PET but has a lower melting point, so that it can be processed at lower temperatures. It is used in applications similar to those of Mylar®. In one embodiment of the invention, a non-marring plastic comprises a PBT. U.S. Pat. No. 5,290,864, incorporated herein by reference, describes thermoplastic PBT resin compositions and polymer blends thereof.

iii. Polycarbonate (PC)

Polycarbonate (PC), marketed under the trademarked names Lexan® and Merlon®, is a special type of polyester used as an engineering plastic. It has exceptional stiffness, mainly by virtue of having more aromatic rings incorporated into the polyester chain. This structure is achieved by reacting bis-phenol A, an aromatic derivative of benzene, with phosgene, a highly reactive and toxic gas. Polycarbonate is highly transparent, has an impact strength considerably higher than most plastics, and can be injection-molded, blow-molded, and extruded. These properties lead to its fabrication into large carboys for water, shatter-proof windows, safety shields, and safety helmets. It is a favored plastic for injection-molding into compact discs (CDs). In certain embodiments of the invention, a non-marring plastic comprises a PC. For example, U.S. Pat. No. 5,633,060, incorporated herein by reference, describes PC resins for use as compact disc recording media, wherein the compact disc has excellent scratch resistance. U.S. Pat. No. 5,011,884, incorporated herein by reference, sets forth ternary blends of the thermoplastics containing liquid-crystalline polyesters, polycarbonate and polyalkylene terephthalate, which are able to withstand considerable bending stresses without breaking.

iv. Alkyds and Oil-Free Coating Polyesters

Alkyds, or alkyd resins, are highly complex network polyesters (e.g., thermosets, cross-linked thermoplastics) that are manufactured for the paint industry. They are made from dicarboxylic acids or their anhydrides and polyfunctional alcohols such as glycerol. To the ester-forming monomers are added modifiers consisting of unsaturated oils such as tung oil, linseed oil, or dehydrated castor oil. The resulting polymers are thus branched polyesters with fatty-acid side groups. Because one of the first alcohols used to produce this type of polymer was glycerol (an alcohol derived from natural oils), the term alkyd has traditionally been used in organic coatings science to denote oil-based derivatives of polyester, while the term polyester is traditionally reserved for oil-free polyesters (described below).

When an alkyd-based coating is applied to a surface, the oil portion of the polyester undergoes a free-radical cross-linking reaction in the presence of oxygen from the surrounding air; this process, known as drying, yields a tack-free surface. A typical alkyd paint consists of the oil-modified polyester to form the coating film, a solvent such as hexane or mineral spirits to aid in application, metal naphthenates to catalyze the drying reaction, and pigment. A long-oil alkyd contains sixty percent fatty acid by weight, a medium-oil alkyd contains forty to sixty percent fatty acid, and a short-oil alkyd contains less than forty percent.

As is stated above, the term polyester, when used in the context of organic surface coatings, indicates a polyester free of natural-oil modifiers. Such polyesters are used extensively in coatings. The polymer can have a linear structure, but it is often branched, and it is usually in a relatively low-molecular-weight form that can be cross-linked to form a film of high performance. When the polyester is synthesized in the presence of an excess of alcohol, it tends to have hydroxyl end-groups on the molecules, and these molecules can be cross-linked through isocyanate, epoxy, and melamine compounds that react with the hydroxyl groups. If an excess of organic acid is present during polymerization, the polyester will have carboxyl end-groups, and these can become sites for cross-linking with epoxy, melamine, and amine groups. Polyesters with free-acid groups attached to their chains can be solubilized to a water-reducible form, as is the case with alkyds. In certain embodiments of the invention, a non-marring plastic comprises an alkyd polyester, a co-polymer thereof or blends thereof.

v. Unsaturated Polyesters

Unsaturated polyesters are linear copolymers containing carbon-carbon double bonds that are capable of undergoing further polymerization in the presence of free-radical initiators. The co-polyesters are prepared from a dicarboxylic acid or its anhydride (usually phthalic anhydride) and an unsaturated dicarboxylic acid or anhydride, along with one or more dialcohols. Most commonly, maleic anhydride provides the unsaturated unit. The linear polymers are subsequently dissolved in a monomer such as styrene and are copolymerized with the styrene in a mold to form a network structure. Glass-fiber reinforcement is almost always used in products made of unsaturated polyesters. The principal applications are boat hulls, appliances, business machines, automobile parts, automobile body patching compounds, tubs and shower stalls, flooring, translucent paneling, storage tanks, corrosion-resistant ducting, and building components. In certain embodiments, a non-marring plastic of the invention comprises an unsaturated polyester.

d. Polyethers

Polyethers are polymers that are formed by the joining of monomers through ether linkages (i.e., two carbon atoms connected to an oxygen atom). A variety of polyethers are manufactured, ranging from plastics to elastomers. The compounds also differ markedly in structure, though they all retain the ether (C—O—C) linkage.

i. Polyacetal

Polyacetal, also called polyoxymethylene (POM) or simply acetal, has the simplest structure of all the polyethers. It is manufactured in a solution process by anionic or cationic chain-growth polymerization of formaldehyde (H₂C═O), a reaction analogous to vinyl polymerization. By itself, the polymer is unstable and reverts to monomer on heating to 250° F.; for this reason the commercial product is reacted further with acetic anhydride to cap the ends of the chains (where de-polymerization is initiated on heating) with acetate groups. Delrin® is an example of the end-capped polymer sold by DuPont® (Wilmington, Del.). It is a high-strength, highly crystalline plastic that exhibits a low coefficient of friction and excellent resistance to oils, greases, and solvents. Polyacetal and copolymers thereof have been used as a replacement for metal in plumbing and automotive parts. Principal uses include appliance parts, electronics components, gears, bushings, bearings, plumbing fixtures, appliances, toys, toiletry and cosmetic articles, food-processing equipment, zippers, and belt buckles. Thus, in certain embodiments of the invention, a non-marring plastic comprises a polyacetal.

ii. Polyphenylene Oxide (PPO)

Polyphenylene oxide is prepared by oxidative coupling of phenylene oxide monomer using oxygen and a copper-based catalyst. The polymer is blended with polystyrene to produce a high-strength, moisture-resistant plastic marketed by General Electric Co. under the name of Noryl®. Polyphenylene oxide is used in telecommunications and computer equipment, automotive parts, appliances, pipes, and valves.

iii. Polyetherketone and Polyetheretherketone

Polyetherketone (PEK) and Polyetheretherketone (PEEK) are high-strength, radiation-resistant plastics whose structures combine both ether and ketone groups. Both are thermally stable and highly resistant to chemicals. Principal uses are in machine parts, nuclear power-plant equipment, automobile parts, aerospace components, cable insulation, and pump parts. U.S. Pat. No. 6,566,484, incorporated herein by reference, describes the formulation of a highly durable PEEK thermoplastic. In certain embodiments of the invention, a non-marring plastic comprises a PEK and/or a PEEK.

iv. Epoxies

Epoxies are polyethers built up from monomers in which the ether group takes the form of a three-membered ring known as the epoxide ring. While many variations exist, the most common epoxy resin is formed from epichlorohydrin and bis-phenol A. These two monomers first form an epoxy pre-polymer that retains two terminal epoxide rings. In a typical epoxy reaction, the pre-polymers are further polymerized through the opening of the terminal epoxide rings by amines or anhydrides. This process, called curing, yields complex, thermosetting network polymers in which the repeating units are linked by linear ether groups. The highly polar network polymers characteristically exhibit excellent adhesive properties. In addition, because the curing reaction is easy to initiate and proceeds quite readily at room temperature, epoxy resins make very useful surface coatings. Most commonly a two-component system is used, in which one component is a low-molecular-weight polymer with amine end-groups and the other component is an epoxide-terminated polymer. The two components are mixed before application to the surface, where the polymer is allowed to cure (e.g., see Example 4).

In certain embodiments of the invention, a non-marring plastic is an epoxy. Epoxide compositions and methods for applying epoxide compositions are well known in the art (U.S. Pat. Nos. 6,045,873, 5,204,387 and 5,059,640, each incorporated herein by reference). Typically, an epoxy resin is applied in either a liquid form or in a solid form used in powder coating.

e. Polyimides

Polyimides are polymers that usually consist of aromatic rings coupled by imide linkages (i.e., linkages in which two carbonyl (CO) groups are attached to the same nitrogen (N) atom. There are two categories of these polymers, condensation and addition. Condensation polyimides are made by step-growth polymerization and are linear in structure. Addition polyimides are synthesized by heat-activated addition polymerization of diimides and have a network structure. Typical of the condensation type is the polyimide Kapton® (sold by DuPont®; Wilmington, Del.) which is made from a dianhydride and a diamine. When the two monomers react, the first product formed is a polyamide. The polyamide can be dissolved in solvents for casting into films, or it can be melted and molded. Conversion to polyimide occurs when the intermediate polyamide is heated above 300° F. Unlike the polyamide, the polyimide is insoluble and infusible. Kapton is stable in inert atmospheres at temperatures up to 930° F. Polyimides are amorphous plastics that characteristically exhibit great temperature stability and high strength, especially in the form of composites. They are used in aircraft components, sporting goods, electronics components, plastic films, and adhesives. In certain embodiments of the invention, a non-marring plastic comprises a polyimide.

f. Polysiloxanes (Silicones)

Polysiloxanes are polymers whose backbones consist of alternating atoms of silicon and oxygen. Although organic substituents are attached to the silicon atoms, lack of carbon in the backbones of the chains makes polysiloxanes into unusual “inorganic” polymers. They exist as elastomers, greases, resins, liquids, and adhesives. Their great inertness, resistance to water and oxidation, and stability at high and low temperatures have led to a wide range of commercial applications.

The most common siloxane polymer, polydimethylsiloxane, is formed when the chlorine atoms of the monomer, dichlorodimethylsilane (Cl₂Si(CH₃)₂), are replaced by hyroxyl (OH) groups by hydrolysis. Siloxane molecules rotate freely around the Si—O bond, so that, even with vinyl, methyl, or phenyl groups attached to the silicon atoms, the molecule is highly flexible. Silicone rubbers are remarkably stable, and they have the lowest glass transition temperature and the highest permeability to gases of any elastomer. The Si—O bond is susceptible to hydrolysis and attack by acids and bases, and the rubber vulcanizates are relatively weak and readily swollen by hydrocarbon oils.

g. Polysulfides

Polysulfides are polymers that contain one or more groups of sulfur atoms in their backbones. They fall into two types: compounds containing a single sulfur atom per repeating unit and compounds containing two or more sulfur atoms. Polyphenylene sulfide is a high-strength, highly crystalline plastic that exhibits good thermal stability and chemical resistance. It is polymerized by reacting dichlorobenzene monomers with sodium sulfide at about 480° F. in a high-boiling, polar solvent. Polymerization is accompanied by loss of sodium chloride. PPS is used principally in automotive and machine parts, appliances, electronic and electrical processing equipment, and coatings. In certain embodiments of the invention, a non-marring plastic comprises a polysulfide.

h. Polyurethanes

Polyurethanes are a class of extremely versatile polymers that are made into flexible and rigid foams, fibers, elastomers, and surface coatings. They are formed by reacting an isocyanate (NCO) group with an alcohol (OH) group. Polyurethane molecules can adopt a linear or a network (e.g., cross-linked) architecture. Linear polyurethanes are formed by reacting a dialcohol with a diisocyanate, whereas network polyurethanes are formed from polyfunctional alcohols or isocyanates.

Polyurethanes form some of the highest-performance coatings available and a variety of polyurethane formulations are marketed. One type is a one-component (one-pot) pre-polymer containing excess isocyanate groups. Upon application of the liquid to a surface, these groups react with water from the atmosphere to form a urea, which further reacts with other isocyanate groups to provide the cross-linking necessary to cure the coating. In another one-pot formulation, the isocyanate groups of the pre-polymer are blocked by a phenol. Curing is accomplished by baking the coating to about 300° F. Alkyd-type one-pot coatings, in which the polyurethane is modified with drying oils, are also available. Polyurethanes are also made into two-component coatings, in which isocyanate-terminated pre-polymers serve as one component and a polyfunctional alcohol serves as the other. When the components are mixed in the presence of a catalyst, the isocyanate and alcohol groups react rapidly to cure the coating.

U.S. Pat. No. 6,100,361, incorporated herein by reference, describes the formulation of polyurethane coatings for protecting the outer surface of golf balls against impact, the coating comprising a two-part solvent borne polyurethane system. The first part of the polyurethane system comprises a hydroxyl functional polyol having a hydroxyl equivalent such as a polyester, polyether or acrylic; or alternately, the hydroxyl functional polyol is a saturated polyether such as poly (oxydiethylene adipates) that are condensation products of diethylene glycol and adipic acid, branched with trimethylolpropane or pentaerythritol, and polycaprolactone (hydroxycaproic acid) polyesters. Polyols marketed by Miles Corporation (Pittsburgh, Pa.), under the name Desmophen™ are particularly contemplated for use herein (e.g., resins such as Desmophen 651A-65, Desmophen 670A-80 and Desmophen 631A-75). The second part of the polyurethane system comprises a blend of (1) an aliphatic diisocyanate (e.g., a dimer or a trimer of hexamethylene diisocyanate (HDI) as described in U.S. Pat. No. 5,549,220, incorporated herein by reference) and (2) an aliphaticlaromatic polyisocyanate copolymer carried in a solvent. Dimers and trimers of HDI contemplated for use herein are sold by Miles Corporation (Pittsburgh, Pa.) under the trademark Desmodur™ (e.g., Desmodur N-3200 is a low viscosity dimer of HDI). Similarly, the aliphatic/aromatic polyisocyanate component contemplated for use are under the trademark Desmodur™ HL. Thus, in certain embodiments of the invention, a non-marring plastic comprises a polyurethane.

i. Ionomer Resins

An ionomer is an ion containing co-polymer. An ionomer resins contains both non-ionic repeat units, and a small amount of ion containing repeat units. The ionic groups make up less than fifteen percent of the polymer. One example of an ionomer is poly(ethylene-co-methacrylic acid). Poly(ethylene-co-methacrylic acid) is a sodium or zinc salt (which provides the ions) comprised of co-polymers derived from ethylene and methacrylic acid.

In an ionomer, the nonpolar chains are grouped together and the polar ionic groups are attracted to each other. This allows thermoplastic ionomers to act in ways similar to that of crosslinked polymers or block copolymers. However, ionomers are not crosslinked polymers, and are in fact a type of thermoplastic called a reversible cross-linker. When heated, the ionic groups will lose their attractions for each other and the chains will move around freely. As the temperature increases, the chains move around faster and faster and the groups cannot stay in their clusters. This allows for a polymer with the properties of an elastomer and the processability of a thermoplastic. Ionomers are sometimes known as thermoplastic elastomers.

In one embodiment, a non-mar polymer of the invention is an ionomer resin (e.g., Surlyn® or Nucrel®). Surlyn® and Nucrel® (DuPont®, Wilmington, Del.) are a family of ionomers of ethylene methacrylic acid. U.S. Pat. No. 3,264,272, incorporated herein by referenced, describes the process of forming ionic copolymers such as an ethylene/methacrylic acid copolymer (i.e., an ionomer). Ionomers such as Surlyn® have a proven history as being extremely impact resistant, which is a highly desirable property of a non-mar coating of the present invention. For example, U.S. Pat. No. 4,445,688, incorporated herein by reference, describes the manufacture of bowling pins having a Surlyn® protective coating. Similarly, U.S. Pat. Nos. 5,567,772 and 6,544,131, each incorporated herein by reference, describe a Surlyn® golf ball cover having improved durability (e.g., cut resistance) and resilience characteristics. U.S. Pat. No. 5,763,062, incorporated herein by reference, describes a safety glass comprising a typical sheet of glass reinforced with a Nucrel® and Surlyn® mixture. Thus, in certain embodiments of the invention, a non-marring plastic comprises Surlyn®, Nucrel®, or a combination thereof.

The polymers (or polymer starting materials) set forth above, should not be construed as limiting the scope of the invention, as the Applicant polymer (e.g., a thermoplastic, a cross-linked thermoplastic, a thermoset or a thermoplastic elastomer) as long as the polymer serves as a “barrier” and protects the work material and/or proximal work material from damage.

3. Additives

In order to derive a set of properties appropriate to the final polymer product, the polymer is often combined with other ingredients, or additives, which are mixed in during processing and fabrication. Among these additives are plasticizers, colorants, reinforcements, fibers and stabilizers.

Plasticizers are used to change the T_{g} of a polymer. For example, polyvinyl chloride (PVC) is often mixed with nonvolatile liquids to change the T_{g}. Vinyl siding used on homes requires an unplasticized, rigid PVC with a T_{g} of 185° to 195° F. A PVC garden hose, on the other hand, should remain flexible even at 32° F. A mixture of thirty parts di(2-ethylhexyl) phthalate (also called dioctyl phthalate, or DOP) with seventy parts PVC will have a T_{g} of about 15° F., making it suitable for use as a garden hose.

Reinforcements are used to enhance the mechanical properties of a plastic. Finely divided silica, graphite, carbon black, talc, mica, and calcium carbonate, as well as short fibers of a variety of materials, can be incorporated as particulate fillers. Incorporating large amounts of particulate filler during the making of plastics such as polypropylene and polyethylene can increase their stiffness.

D. Processes for Applying Polymers

A non-marring polymer of the invention is applied to a tool or fastener head by methods known to those of skill in the art. As described supra in section C, a non-marring polymer of the invention comprises a plastic, an elastomer, a thermoplastic elastomer, a plastic blended or formulated with a man-made fiber, an elastomer blended or formulated with a man made fiber, a thermoplastic elastomer blended or formulated with a man made fiber and combinations thereof. In certain embodiments, a non-marring polymer is applied to the tool as a spray. In other embodiments, a non-marring polymer is applied to the tool by dipping the tool into a vessel containing the polymer. In still other embodiments, a non-marring polymer is applied by painting the tool with a liquid polymer. The following non-limiting examples describe various processes known in the art for applying polymers or polymer coatings.

Thermoplastic resins are often supplied as cylindrical pellets (several millimeters in diameter and length) or as flakes and powders. Other forms include viscous liquids, solutions, and suspensions. Thermoplastics are changed into useful shapes by using many different processes. The processes that are used to mold or shape thermoplastics basically soften the plastic material so it can be injected into a mold, flowed through a die, formed in or over a mold, spayed (or brushed) directly onto a part, etc. The processes usually allow any scrap parts or material to be ground up and reused. Some of the more common processes are injection molding, extrusion, blow molding, rotational molding, calendering, forming, thermoforming (which includes vacuum forming), casting, brushing, spraying, dipping, fluidized bed coating, and the like.

Cross-linked thermoplastics and thermosets must use a process that allows the material to flow to the desired shape and then become crosslinked and rigid. The material cannot be remelted or reused after crosslinking occurs (e.g., epoxies). Some of the processes commonly used to process these materials are injection molding, transfer molding, compression molding, hand (or spray) lay-up, dipping, spraying, brushing, lamination, and filament winding.

Elastomer processing typically consists of four basic steps: (1) mastication, when the elastomer is sheared and the molecules are broken down to give easier flow, (2) mixing, usually carried out immediately after mastication, when additives are incorporated, (3) shaping of the viscous mass, for example, by extrusion or molding, and (4) curing, when the polymer molecules become interlinked and the shape is fixed. Elastomers often are injection molded, transfer molded, compression molded or extruded.

In certain embodiments of the invention, the outer surface of a wrench jaw, a socket jaw or a plier jaw is coated with a non-marring polymer, but the inner jaw surface is not coated (i.e., the inner jaw retains its native composition). In these embodiments, depending on the method of polymer application, the inner jaw surface(s) of the tool is blocked or masked by methods known to one of skill in the art of polymer processing, such that the polymer is excluded from the inner jaw surface(s). Companies such as Niagara Plastics (Erie, Pa.; Part No. WCT075) and EPSIO (Menomonee Falls, Wis.; Part No. K12-00032) sell high-temperature tapes specifically designed for masking material for thick polymer coatings.

For example, the high-temperature tapes sold by Niagara Plastics are fiber-glass tapes specifically withstanding extended polymer cure cycles up to 500° F. The tape has a woven fiber-glass backing coated with a high-temperature silicone adhesive which allows for easy removal and will not splinter. High-temperature tapes sold by EPSI® include a UL approved polyimide (K12) tape which combines a 1.6 mm high-temperature pressure sensitive adhesive with a 1.0 mm flexible carrier. Heat resistant sealants and “jackets” such as Pyrosealant™ and Pyrojacket™, respectively, are also used to block or mask a desired surface of a tool from the polymer coating process. Pyrosealant™ (ADL Insuflex®, Inc.; Ontario, Canada) is a heat resistant iron oxide red sealant material that cures at room temperature into a tough rubbery solid. It is composed of amorphous silica, polydimethyl-siloxane, iron oxide and a specially developed curing catalyst to facilitate a moisture sensitive cure at room temperature within approximately 18 hours. Pyrosealant™ dries to a tack-free state in 10-15 minutes and has a continuous temperature rating of 500° F. and intermittent exposure to 1,000° F. Pyrojacket™ (ADL Insuflex®, Inc.; Ontario, Canada) is a high bulk heat resistant fiberglass sleeve, heavily coated with iron oxide red silicone rubber and withstands continuous exposure to 500° F., up to 2,000° F. for 15-20 minutes, and up to 3,000° F. (1650° C.) for 15-30 seconds. Alternatively, following the polymer application process, the polymer is excised from the inner jaw surface by cutting, grinding, heating, etc. the polymer.

In certain other embodiments, the outer jaw surface and the inner jaw surface of a wrench jaw or a socket jaw is coated with a non-marring polymer. As described previously, the torque administering (or contact) surfaces (i.e., the inner jaw surface) of a non-adjustable wrench or socket comprise standard sizes, measured either in metric or English (i.e., Society of Automotive Engineers, SAE) dimensions, so that a fastener head is engaged by the standard size wrench or socket. When the inner surface of a wrench or a socket are to be coated with a particular non-marring polymer, the thickness of the polymer coating is determined or calculated. The inner jaw dimensions of the wrench or socket are modified accordingly to compensate for the polymer thickness, thereby ensuring that the contact surfaces of the wrench or socket retain their standard size following the application of the polymer coating to the inner jaw surface. The inner jaw dimensions are reduced, for example, by casting, forging or forming the metal wrench or socket such that the inner jaws dimensions are reduced according to the desired polymer thickness or by machining metal off of the inner jaw surfaces to compensate for polymer thickness. Alternatively, a larger jaw size is used and the polymer thickness is adjusted to yield the desired jaw size.

As a non-limiting example, assume that the inner jaw of a 15 mm open-end wrench is to be coated with a polymer having a thickness of 0.5 mm. In this example, the open-end wrench is a conventional U-shape open-end wrench having two parallel torque administering (or contact) surfaces, separated by a distance of 15 mm (i.e., an inner jaw size of 15 mm measured across the parallel torque receiving surfaces), wherein the torque administering surfaces engage a threaded fastener having a 15 mm head portion. After applying the 0.5 mm polymer coating to the inner jaw surfaces (i.e., 2 jaw surfaces×0.5 mm polymer thickness=1.0 mm total polymer thickness), the distance across the two torque administering surfaces is reduced to 14 mm and as such, the inner jaw will not engage the 15 mm fastener head. Thus, for an open-end wrench having two parallel torque receiving surfaces, the following equation is used to correct for polymer thickness:
A−(B×2)=Y;
wherein A is the desired jaw size after applying the polymer coating, B is the polymer thickness and Y is the corrected jaw size. For example, using the dimensions set forth supra (A=15 mm, B=0.5 mm), the corrected jaw size (Y) is 15 mm−(0.5 mm×2)=14 mm. Thus, to correct for the 0.5 mm polymer thickness, (1) the two torque receiving surfaces of the inner jaw are each reduced by 0.5 mm (e.g., by machining 0.5 mm of metal from the jaw surfaces) before the polymer coating is applied or (2) the jaw size is corrected by casting, forging or forming the wrench having a 1 mm reduction in jaw size or (3) a 16 mm jaw size is used, wherein applying the 0.5 mm polymer to both contact surfaces yields a coated jaw size of 15 mm. Similarly, the jaw size(s) for hexagonal head wrenches (and sockets), Allen head wrenches (and sockets), Torx head wrenches (and sockets), twelve-point head wrenches (and sockets) and the like are adjusted for polymer thickness.

a. Injection Molding

“Injection Molding” is used to make three dimensional shapes with great detail. For example, the thermoplastic plastic material is placed in a hopper of an injection molding machine where it is fed into a chamber to be melted. The melting is achieved by conducting heat into the material in a “plunger” machine, while the material is primarily heated by shearing or mechanically working the polymer in a “screw” machine. Several shots of plastic material are being heated and held in the injection unit. The maximum volume of material a machine can inject in a single shot determines its shot capacity. The capacity is given in ounces of a material.

Once melted the plastic is forced, under pressure, into the mold where it conforms to the shape of the cavity. The mold is temperature controlled, usually by circulating temperature controlled water through it. Once the part is cooled, the mold is opened and the part removed. The mold is then closed and ready for the next is shot. The mold is clamped shut while the material is being injected in to the cavity since the cavity pressure may be as much as 5,000 psi. The clamp is sized by the “tonnage” it holds. Injection molding machines are referred to by their shot size in ounces and their tons of clamping ability.

The molds are most often made out of hardened steel and carefully finished. They are also made out of pre-hard steel, aluminum, epoxy, etc. The type of mold material selected depends on the number of parts to be made and the plastic material to be used.

The injection molding of a thermoset or a cross-linked thermoplastic is similar to the injection molding of linear thermoplastics, except the material is kept cool until it is pushed into the heated mold where it is crosslinked. The mold is then opened and the hot, but rigid, part is removed. Injection molding of an elastomer involves forcing the elastomer through channels into a mold chamber of the required shape, where it is cured under pressure. The curing (i.e. cross-linking) of elastomers is generally carried out by heating the elastomer with steam, electricity or microwave irradiation in the presence of a chemical cross-linker or a free radical initiating process.

b. Extrusion

“Extrusion” is like squeezing toothpaste out of its tube. The process produces continuous two-dimensional shapes like sheet, pipe, film, tubing, gasketing, etc. For example, a plastic material is fed into the extruder where it is melted and pumped out of the extrusion die. The die and the take-off line shape the plastic material as it cools and control the final dimensions of the cross-section of the shape. The equipment is designed and controlled to produce melted plastic at a very uniform temperature and pressure which control the size and quality of the extruded product. The extrusion of thermosets, cross-linked thermoplastics and elastomers generally omits the step of heating or melting these polymers as they are most typically liquids at room temperatures.

c. Extrusion Blow Molding

“Blow molding” or “extrusion blow molding” is process wherein a mold is manufactured in the shape of the tool and then a fluid polymer is blown into the mold with high pressure air. The polymer takes the shape of the tool and upon cooling results in a polymer sheath. For example, polymers such as polycarbonate (e.g., Lexan®)), PVC, low density polyethylene (LDPE), high density polyethylene (HDPE) and polypropylene are blow molded to make products such as plastic milk bottles, windshield washer reservoirs, flotation buoys and the like.

d. Forming and Thermoforming

The process of forming plastics into various shapes typically involves the steps of melting, shaping, and solidifying. As an example, polyethylene pellets are heated above their Tₘ, placed in a mold under pressure, and cooled to below their Tₘ in order to make the final product dimensionally stable. Thermoplastics in general are solidified by cooling below T_{g} or Tₘ. Thermosets, cross-lined thermoplastic and elastomers are solidified by heating or chemical reaction in order to carry out the cross-linking reactions necessary for polymer network formation.

An extruded or cast thermoplastic sheet can be heated, draped over a mold, and allowed to cool to produce a polymer coating, which is a process known as thermoforming. Two types of thermoforming are typically used, vacuum forming and pressure forming. In the vacuum forming process, cut-to-size polymer sheets are heated in ovens which use ceramic or gas heaters and zone controls to maintain an accurate measurement and control of the polymer sheet temperature. The sheet is then placed over a mold and a vacuum is applied pulling the sheet into the shape of the mold. Pressure forming is a process similar to vacuum forming, except with the addition of pressure which pushes the sheet into the shape of the mold. Pressure forming is often used for parts that require styling and aesthetic qualities because pressure forming creates greater detail allowing for textured surfaces, undercuts and sharp corners which are not as easily created with vacuum forming. Some examples of plastic parts made using thermoforming processes include signs, skylights, bubble packaging and boat/motorcycle windshields.

e. Casting

The process of casting typically involves pouring a liquid polymer into a mold and hardening the polymer. Tubing, rods, sheets, and slabs are often made via casting.

f. Spraying, Brushing and Dipping

A thermoplastic polymer, after being heated to a liquid state, is sprayed or brushed onto a tool or the tool dipped into a polymer bath; and subsequently cooled back down to a solid state. A thermoset, a cross-linked thermoplastic polymer or an elastomer are also applied by spraying the tool with the liquid polymer, brushing the tool with the liquid polymer or dipping the tool into the liquid polymer and allowing the polymer to harden via cross-linking.

g. Dry Powder Coatings

Dry powder coatings are plastic polymers that, upon application of heat, melt and flow out to a continuous and even film. Nylons, epoxies, vinyls, polyolefins, polyesters and polyethylenes are the polymers most frequently used for dry powder coating. The five basic methods used to apply plastic (dry powder) coatings are (a) fluidized bed coating, (b) electrostatic spray coating (often generically referred to as powder coating, (c) flame spray coating, (d) dip-to-line coating, and (e) flo-cad coating (also referred to as mini-coat).

i. Fluidized Bed

“Fluidized bed” coating is a well known method consisting of a fluidized bed, which is typically a tank of dry powdered plastic that is aerated from below. The aeration causes the plastic particles to become suspended, making a fluid-like “bath” of turbulent particles. When a preheated metal tool is immersed in the tank, the plastic particles melt and adhere to its hot surface. When the tool is removed, all the particles on the surface fuse into a continuous coating (often referred to as flow out). If necessary, the tool is placed in an oven for additional curing.

ii. Electrostatic Spray

“Electrostatic spray” coating is a process well known in the art (U.S. Pat. No. 6,325,846, incorporated herein by reference). For example, the tool is electrostatically charged, coated with an electrically chargeable dry powder plastic (e.g., a polyester resin) and the resin activated via heating (i.e., thermosetting) or the addition of a curing agent (e.g., see U.S. Pat. No. 6,303,706, incorporated herein by reference).

iii. Flame Spray

“Flame spray” coating utilizes a hand-held spray applicator, with the dry plastic powder being fed into a propane/compressed air-fueled flame, where it is melted and then blown against the surface of the tool at a high velocity. The plastic polymer immediately bonds with the tool, resulting in an extremely tough, tightly adhering coating.

h. Transfer Molding

In transfer molding a thermoset, elastomer or cross-linked thermoplastic, only enough polymer material for one shot is placed in a separate chamber or pot. The material is then pushed from the pot into the hot mold and crosslinked. All of the “cured” material is removed from the machine and another charge loaded for the next shot.

i. Compression Molding

In compression molding a thermoset, a cross-linked thermoplastic or an elastomer, a single charge of the polymer material is placed directly into the cavity of the heated mold. The polymer flows and fills the cavity as the mold closes. The mold is kept closed until the polymer crosslinks. All of the cured material is removed from the mold prior to recharging the cavity. In one form of compression molding, a layer of reinforcing material is laid down before the polymer is introduced, thereby

j. Spray Lay-Up

“Spray lay-up” is used to produce products, such as fiberglass boats and camper shells. The plastic resin (e.g., a polyester), is rolled or sprayed with glass reinforcement into a mold. A catalyst is added to the material to cause the material to crosslink or harden at room temperature. This process lends itself to making large and strong parts.

k. Filament Winding

Filament winding is an automated version of the spray lay-up process. Reinforcing filaments are covered with a plastic resin and then wound over a mandrel. The number of layers and orientation are varied depending on the load that the part is to carry. A strong thin hollow part is left after the mandrel is removed. Storage tanks and street lighting poles are some examples of filament wound parts.

### E. EXAMPLES

The following examples are carried out using standard techniques, which are well known and routine to those of skill in the art, except where otherwise described in detail. The following examples are presented for illustrative purpose, and should not be construed in any way limiting the scope of this invention.

### Example 1

### Pre-Coating Preparation of the Tools

It is important, to ensure proper bonding of the polymer to the tool, that the metal surface of the tool is essentially free of contaminants such as oils, grease, oxidation and gases. Thus, a tool of the invention is first cleaned by grit (or shot) blasting, abrasive wheel grinding or similar abrasive methods. Grit blasting serves to remove surface contaminants from the tool and provides a mechanical surface for the polymer coating to adhere. In order to ensure a clean surface, just prior to applying the polymer coating, the tool is degreased with a solvent such as denatured ethanol and/or an aqueous detergent and allowed to air dry. Alternatively, surface contaminants on the metal are removed by hot alkaline water rinse, sand blasting, vapor degreasing, acid etching with phosphoric acid, hydrofluoric acid, etc. Thus, the general rule of thumb is that the cleaner the tool surface, the better the polymer will bond to the surface. After cleaning the tool, avoid touching the surfaces and coat the tool as soon as possible.

Depending on the method of polymer application (e.g., powder/electrostatic coating), certain metals, such as galvanized steel, may require degassing to yield a suitable polymer bond to the metal. Metal gassing usually occurs when air or water is trapped in the porous areas of the metal surface. Air gassing is caused when air is resident in the metal generally due to its porosity. For example, on heating the polymer coated tool in a cure oven, the air gas expands and releases through the polymer coating to form a small “volcano” or crater. Water gassing is caused by small quantities of water residing in the metal when it is porous. This type of gassing manifests itself by a large number of small “dots” in the polymer coating. If water gassing is excessive, the smaller bubbles will join up and form a larger blister where all adhesion will be lost. Methods for degassing metals are well known in the art. Typically, the metal tool is heated in an oven at a minimum temperature of 20° C. above the coating process temperature, for a time of at least as long as the heating period used in the coating process.

### Example 2

### Coating a Tool with Nylon

In this example, a lever tool was coated with nylon. A 20 cm long by 2 cm wide lever (part No. 08-0003; Motion Pro®, Inc.; San Carlos, Calif.) was cleaned by thoroughly sand blasting the entirety of lever. A thermoplastic nylon powder (Nylon 12, Continental Industries, Inc.; Tualatin, Oreg.) was then applied to the lever by fluidized bed coating. Nylon 12 (also referred to as polyamide 12) has a melting temperature of about 350° F., a 300% elongation at break, a tensile strength of 3,626 psi and a Rockwell hardness value of R80. The lever was pre-heated to 500° F. and dipped into the fluid bed, with a flow out at 450° F. for ten minutes and then cooled to ambient temperature.

### Example 3

### Coating a Tool with a Modified Polyvinylidene Fluoride (PVDF)

In this example, a lever tool was coated with polyvinylidene fluoride (PVDF). A lever (part No. 08-0003; Motion Pro®, Inc.) was cleaned by thoroughly sand blasting the entirety of lever. An electrostatic grade PVDF powder (PVDF2-Plus™; Continental Industries, Inc.) was applied to the lever by the hot-flocking method. PVDF2-Plus™ is a copolymer of difluoroethylene and hexafluorpropylene with a Shore D hardness of 80, a 0.17 dynamic coefficient of friction and a melting temperature of 320° F. The lever was pre-heated to 500° F., hot flocked with PVDF2-Plus™, with a flow out at 500° F. for twenty minutes. This was repeated three times.

### Example 4

### Coating a Tool with an Epoxy Thermoset

In this example, a lever (Part No. 08-0003; Motion Pro®), a ¾ inch combination wrench (Part No. 45981; Sears, Roebuck and Co.) and a 6-point 5 mm (¼ inch drive) socket (Part No. 43501; Sears, Roebuck and Co.) were coated with an epoxy. Each tool was first cleaned by abrading with a 6×¾ inch crimped medium face wire wheel brush (Part No. 64129; Sears, Roebuck and Co.) mounted to a 6 inch, 2.8 Amp bench grinder (Part No. 21106; Sears, Roebuck and Co.), wherein the wire wheel brush was spinning at 3,450 rpm. Following the abrasion step, the tools were washed in mild detergent, blown dry with compressed air and solvent wiped with denatured ethanol.

The epoxy used to coat the tools was purchased from Abatron, Inc. (Kenosha, Wis.). The Abatron epoxy is a two-part solvent based system comprising: (A) the epoxy resin (Abocoat 8508-1A; Abatron, Inc.) and (B) the epoxy hardener or curing agent (Abocure 8508-1B; Abatron, Inc.). The epoxy resin and the harder were mixed 1:1 by volume. Thus, 50 mL of the epoxy resin and 50 mL of the hardener were added to a one pint mixing can, stirred for five minutes and allowed to react for one hour at room temperature. The epoxy was then poured into a flat bottom paint mixing tray and the tools dipped into the epoxy for thirty seconds. The tools were then removed from the tray and cured at room temperature for one hour. A second coating of epoxy was applied by again dipping the tools into the epoxy for thirty seconds. Following this second dip, the epoxy coated tools were allowed to cure for twenty-four hours.

### Example 5

### Coating a Tool with a Polyurethane Thermoset

In this example, a lever (Part No. 08-0003; Motion Pro®), a ¾ inch combination wrench (Part No. 45981; Sears, Roebuck and Co.) and a 6-point 5 mm (¼ inch drive) socket (Part No. 43501; Sears, Roebuck and Co.) were coated with a polyurethane. The tools were prepared as described in Example 4. A thermoset polyurethane coating was prepared as follows: (A) 200 mL of Abothane liquid polyurethane resin (Abothane 8901-4A; Abatron, Inc.; Kenosha, Wis.) was added to (B) 100 mL of Abocure liquid polyisocyanate curing resin (Abothane 8901-4B; Abatron, Inc.), and mixed by stirring for two minutes in a paint mixing tray. The overall viscosity was reduced by adding (C) 70 mL of the proprietary organic solvent Absolv (Absolv 8901-4; Abothane 8901-4B; Abatron, Inc.) to the polyurethane solution and mixed by stirring for five minutes. The final polyurethane formulation (i.e., 370 mL of A+B+C) was divided in half, wherein two paint mixing trays (tray one and tray two) contained about 185 mL of the final polyurethane formulation. To test the effects of a lubricious graphite filler, four grams of extra fine graphite (MicroFyne graphite, lot No. D547, 49 microns; Dixon Lubricants and Specialty Products; Asbury, N.J.) were added to mixing tray two and mixed by stirring for two minutes. The polyurethane in trays one and two was then allowed an initial curing set-up time of thirty minutes, after which time a tool was dipped into tray one for about thirty seconds and a second tool dipped into tray two for about thirty seconds. The tools were then removed from the trays and cured at room temperature for thirty minutes. A second coat of polyurethane was applied as described above and the polyurethane coated tools (+/−graphite) were allowed to cure for twenty-four hours.

### Example 6

### Coating a Tool with Teflon-Protekote 92

In this example, a lever tool was coated with a Teflon® derived polymer sold under the trade name of Protekote-92 (Pro-Tek Coatings, Ltd.; Winnipeg, Manitoba Canada). The lever (Part No. 08-0003; Motion Pro®, Inc.) was cleaned by thoroughly sand blasting the entirety of lever and the Protekote-92 was applied to the lever by the fluidized bed coating as described previously.

### Example 7

### Coating the Outer Surface of a Socket Tool with Epoxy

In this example, the outer surface of a 6-point 5 mm (¼ inch drive) socket (Part No. 43501; Sears, Roebuck and Co.) was coated with an epoxy. The socket was abraded and cleaned as described in Example 4. The socket's inner jaw surface (i.e., contact or torque administering surface) was masked by completely filling the socket's inner jaw surface with an. 88 mL tube of 3M™ Ultrapro™ high-temperature silicone (3M™, St. Paul, Minn.; Part No. 08672). The epoxy was applied as described in Example 4. After the epoxy fully cured, the high-temperature silicone was removed from the inner jaw surface by scraping with a dull flat head screwdriver. The inner socket jaw was wiped clean with denatured ethanol. Thus, the final epoxy coated socket comprised the epoxy coating on its outer surface, wherein the inner jaw (or torque administering surface) was an epoxy free bare metal.

### Example 8

### Coating a Tool with Plastidip®

In this example, a lever (Part No. 08-0003; Motion Pro®) and a ¾ inch combination wrench (Part No. 45981; Sears, Roebuck and Co.) were coated with PlastiDip®, which is a commercially available elastomer (Plasti Dip® International; Blaine, Minn.) sold in most hardware and home improvement stores. The PlastiDip® material includes rubbers such as styrene-ethylene/butylene-styrene (SEBS) and styrene-ethylene/propylene-styrene (SEPS), along with solvents, plasticizers, etc., including 1,1,1-trichloroethane, VM&P naphtha, toluene, heptane and materials such as antioxidants. The tools were abraded and cleaned as described in Example 4. The tools were dipped directly into a 429 mL can of yellow PlastiDip and cured at ambient temperature for twenty-four hours.

### Example 9

### Coating a Tool with Surlyn®

Ionomer resins such as Surlyn®, manufactured by DuPont®, comprise ionically cross-linked ethylene-methacrylic acid and ethylene-acrylic acid copolymers. Properties which distinguish these ionomer resins from other polyolefin heat-seal polymers are high clarity, tear resistance, abrasion resistance, solid-state toughness and resistance to oil-fat permeation.

Ionic copolymers such as Surlyn® comprise a polymer of an α-olefin having the general formula RCH═CH₂, where R is a radical selected from the class consisting of hydrogen and alkyl radicals having 1 to 8 carbon atoms, the olefin content of the polymer being at least 50 mol percent based on the polymer, and an α,β-ethylenically unsaturated carboxylic acid having 1 or 2 carboxylic acid groups, the acid monomer content of the polymer being from 0.2 to 25 mol percent based on the polymer. The carboxylic acid-containing polymer contains uniformly distributed throughout the polymer one or more metal ions having ionized valences of 1 to 3 inclusive where the acid comonomer is monocarboxylic, and an ionized valence of one where the acid monomer is dicarboxylic, the quantity of the metal ion being sufficient to neutralize at least 10 percent of the carboxylic acid. For a complete description of ionomer formulation, cross-linking and the like, see U.S. Pat. No. 3,264,272, incorporated herein by reference.

Various grades of ionomer resins are available for extrusion coating, film coating and the like. Table 4 is representative of a typical ionomer grades and their formulation.

TABLE 4
IONOMER FORMULATIONS

| | Parts by Weight | | |
|---|---|---|---|
| Formulation | I | II | III |
| Hi-milan 1605^{a} | 5 | — | — |
| Hi-milan 1555^{b} | 10 | — | — |
| Hi-milan 1855^{c} | 85 | — | — |
| Surlyn AD8512^{d} | — | 25 | 30 |
| Surlyn AD8511^{e} | — | 25 | 30 |
| Epofriend A1010^{f} | — | 15 | 40 |
| Septon HG-252^{g} | — | 35 | — |
| Titanium dioxide | 2.0 | 2.0 | 2.0 |
| Barium sulfate | 2.0 | 2.0 | 2.0 |

^{a}Hi-milan ™ 1605 (trade name), ethylene-methacrylic acid copolymer ionomer resin.
^{b}Hi-milan ™ 1555 (trade name), ethylene-methacrylic acid copolymer ionomer resin.
^{c}Hi-milan ™ 1855 (trade name), ethylene-methacrylic acid-isobutyl acrylate terpolymer ionomer resin.
^{d}Surlyn ® AD8512 (trade name), ethylene-methacrylic acid copolymer ionomer resin.
^{e}Surlyn ® AD8511 (trade name), ethylene-methacrylic acid copolymer ionomer resin.
^{f}Epofriend ™ AT1010 (trade name), styrene-butadiene-styrene block copolymer with epoxy groups. Styrene/butadiene (weight ratio) = 40/60, content of epoxy = 1.5 to 1.7% by weight.
^{g}Septon ™ HG-252 (trade name), hydrogenated styrene-isoprene-styrene block copolymer having terminal —OH group.

A sufficient quantity of ionomer resin pellets (e.g., Surlyn® 1707) are injection molded or compression molded to the outer surface of a tool (e.g., under a force of 10 to 45 tons and at a temperature of 300° F. to 350° F.). The tool is cooled to about 120° F. and taken from the mold.

The examples set forth above should not be construed as limiting in any way, as they merely provide guidance for one of skill in the art. Variations of these methods and alternative methods are contemplated for applying coatings and are readily apparent to one of skill in the art.

### Example 10

### Testing the Non-Marring Properties of Various Polymers

Polymer Scratch (Mar) Test

In this example, the protective effect of a polymer coated lever contacting (rubbing against) another metal was simulated as follows: A piece of 12 inch×18 inch stainless steel sheet metal (twenty six gauge) was polished to a mirror like finish using an automotive steel and aluminum wheel polish. The metal sheet was then wiped clean with denatured ethanol to remove any trace of the wheel polish. The metal sheet was then evenly divided into a grid of twenty-four squares (3 inch×3 inch squares) by marking the sheet with a Sharpie® pen. Table 5 below shows the grid divided into twenty-four squares, the polymer which was rubbed in each square and the qualitative polymer performance score of zero, one, two or three, with one being the worst score and three the best.

The test consisted of rubbing a polymer (or a positive control) in its assigned grid space listed Table 5. Each polymer was rubbed diagonally in a back and forth motion, starting in the bottom left grid corner and ending at the upper right grid corner, for a total of twenty rubs. Grid number seven was a control grid in which nothing was rubbed, and thus served as a visual calibration for non-marring. Grid numbers fifteen and sixteen were control grids in which a tungsten carbide cutter and a bare steel (non-coated) lever were rubbed, respectively, and thus served as positive controls for scratch/marring.

The scoring system is as follows: (a) a score of zero was assigned to any polymer which scratched its grid, wherein a scratch is visible as a diagonal indentation or scratch in metal surface. A score of one was assigned to any polymer that did not scratch its grid, but had low lubricity (or high friction). A score of two was assigned to any polymer that did not scratch its grid, had high lubricity (or low friction), but left a trace amount of polymer residue on the metal surface. It should be noted that the polymer residue observed for score two polymers was readily wiped from the metal surface with either denatured ethanol or mild detergent. A score of three was assigned to any polymer that did not scratch its grid, had high lubricity (or low friction) and did not leave a polymer residue on the metal surface.

TABLE 5
POLYMER SCRATCH TEST

| | | | | | |
|---|---|---|---|---|---|
| 1 | 2 | 3 | 4 | 5 | 6 |
| Plasti-Dip ® | Epoxy | PVDF | PVC | Tivar 1000 | Tivar DrySlide |
| 1 | 2 | 2 | 3 | 3 | 2 |
| 7 | 8 | 9 | 10 | 11 | 12 |
| (−) Control | Nylon 12 | Polycarbonate | Lucite | LPDE | |
| 3 | 3 | 3 | 3 | 2 | |
| 13 | 14 | 15 | 16 | 17 | 18 |
| Neoprene | Teflon Sheet | (+) Control | (+) Control | PP clear | PP white |
| 1 | 3 | Carbide cutter | Steel Lever | 3 | 2 |
| | | 0 | 0 | | |
| 19 | 20 | 21 | 22 | 23 | 24 |
| Polyurethane + | Polyurethane | Protekote 92 | Kydex sheath | Sanalite | HDPE |
| 3 | 3 | 2 | 2 | 3 | 2 |

The scratch test was designed to measure (qualitatively) the ability of the steel sheet to withstand the friction applied by rubbing various polymers The following is a brief description of each polymer tested:

1. The Plasti-Dip® sample used in grid 1 (score 1) was the coated lever described in Example 8.

2. The epoxy sample used in grid 2 (score 2) was the coated lever described in Example 4.

3. The polyvinylidene fluoride (PVDF) sample used in grid 3 (score 2) was the coated lever described in Example 3.

4. The polyvinyl chloride (PVC) sample used in grid 4 (score 3) was a grade 1, type 1 PVC, which was obtained as a small rectangular block (2 inch width×4 inch length×⅛ inch thickness) from Interstate Plastics (Sacramento, Calif.).

5. The Tivar®1000 sample used in grid 5 (score 3) was an ultra high molecular weight polyethylene (UHMWPE), which was obtained as a small rectangular block from Interstate Plastics.

6. The Tivar® DrySlide sample used in grid 6 (score 2) was a modified ultra high molecular weight polyethylene (UHMWPE), which was obtained as a small rectangular block from Interstate Plastics.

7. The Nylon 12 sample used in grid 8 (score 3) was the coated lever described in Example 2.

8. The polycarbonate sample used in grid 9 (score 3) was a 4×4 inch square sheet (1/32 inch thickness) obtained from Interstate Plastics.

9. The Lucite sample used in grid 10 (score 3) was a 4 inch×4 inch square sheet (1/32 inch thickness) obtained from Interstate Plastics.

10. The low density polyethylene (LDPE) sample used in grid 11 (score 2) was obtained as a small rectangular block from Interstate Plastics.

11. The neoprene rubber sample used in grid 13 (score 1) was a neoprene O-ring obtained at a local automotive store.

12. The Teflon® sheet used in grid 14 (score 3) was a 4×4 inch square sheet (1/32 inch thickness) obtained from Interstate Plastics.

13. The tungsten carbide cutter used as a positive control in grid 15 (score 0) was obtained local hardware store (Dremel® Part No. 9933).

14. The non-coated lever used a positive control in grid 16 (score 0) was a Motion Pro® lever (part No. 08-0003).

15. The polypropylene (PP) sample used in grid 17 (score 3) was a clear polypropylene homopolymer, which was obtained as a small rectangular block from Interstate Plastics.

16. The polypropylene (PP) sample used in grid 18 (score 2) was a white pigmented polypropylene homopolymer, which was obtained as a small rectangular block from Interstate Plastics.

17. The polyurethane sample used in grid 19 (score 3) was the polyurethane plus graphite coated tire lever described in Example 5.

18. The polyurethane sample used in grid 20 (score 3) was the polyurethane coated lever described in Example 5.

19. The Protekote-92 sample used in grid 21 (score 3) was the Protekote-92 coated lever described in Example 6.

20. The Kydex® sample used in grid 22 (score 2) was a Kydex® sheet (Kleerdex Company; Aiken, S.C.) thermoformed around one half of the lever.

21. The Sanalite® used in grid 23 (score 3) was obtained as a small rectangular block from Interstate Plastics.

22. The high density polyethylene (HDPE) used in grid 24 (score 3) was obtained as a small rectangular block from Interstate Plastics.

Additional Abrasion Resistance Test Methods

Additionally, a number of quantitative abrasion resistance test methods may be employed, including but not limited to the Taber Test (ASTM D-4060), the Tumble Test and Standard Method for the Modified Bayer Test (ASTM F735-81). There are also qualitative test methods that may be used for measuring abrasion resistance, including the Steel Wool Test and the Eraser Test. In the Steel Wool Test and the Eraser Test, coated tool samples are scratched under reproducible conditions (constant load, frequency, etc.). The scratched test samples are then compared and rated against standard samples. A semi-quantitative application of these test methods involves the use of an instrument, such as a Spectrophotometer or a Colorimeter, for measuring the scratches on the coated substrate as a haze gain.

1. An open-end wrench comprising an open-end jaw, wherein the open-end jaw comprises an inner jaw surface comprising a torque administering surface and an outer jaw surface, wherein the outer jaw surface comprises a polymer coating.

2. The wrench of claim 1, further defined as comprising (1) a lever body having a first end and a second end and (2) an open-end jaw at one end of the lever body, wherein the open-end jaw comprises (a) an inner jaw surface comprising two or more torque administering surfaces for engaging and torqueing the head of a fastener and (b) an outer jaw surface which does not engage the head of the fastener, wherein the outer jaw surface comprises a polymer coating.

3. The wrench of claim 2, wherein the lever body comprises an open end jaw at both ends of the lever body.

4. The wrench of claim 1, further comprising a polymer coating on the inner jaw surface.

5. The wrench of claim 1, wherein the entirety of the wrench comprises a polymer coating.

6. The wrench of claim 1, wherein the polymer is selected from the group consisting of a polyisocyanate, a polyurethane, a polyester, a polyethylene, an ultra high molecular weight polyethylene (UHMWPE), a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, a polycarbonate/acetonitrile-butadiene-styrene (ABS) alloy, a fluoropolymer, an ionomer resin, a polyamide, a polyimide, a polyamideimide, a vinyl acetate, a co-polymer thereof, a polymer blend thereof or a combination thereof.

7. A closed-end wrench comprising a closed-end jaw, wherein the closed-end jaw comprises an inner jaw surface comprising a polygonal torque administering surface and an outer jaw surface, wherein the outer jaw surface comprises a polymer coating.

8. The wrench of claim 7, further defined as comprising (1) a lever body having a first end and a second end and (2) a closed-end jaw at one end of the lever body, wherein the closed-end jaw comprises (a) an inner jaw surface comprising a polygonal torque administering surface and (b) an outer jaw surface, wherein the outer jaw surface comprises a polymer coating.

9. The wrench of claim 8, wherein the lever body comprises a closed-end jaw at both ends of the lever body.

10. The wrench of claim 7, wherein the entirety of the wrench comprises a polymer coating.

11. The wrench of claim 6, wherein the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, an ABS alloy, a fluoropolymer, an ionomer resin, a polyamide, a polyimide, a polyamideimide, a vinyl acetate, a co-polymer thereof, a polymer blend thereof or a combination thereof.

12. A kit comprising (1) a threaded bolt fastener comprising a polygonal head, wherein the polygonal head consists of a polymer coating and (2) an open-end wrench of claim 1.

13. The kit of claim 12, further comprising a threaded nut fastener comprising polygonal outer surface and a threaded helical inner surface for securing a bolt or screw, wherein the outer surface consists of a polymer coating.

14. A kit comprising (1) a threaded bolt fastener comprising a polygonal head, wherein the polygonal head consists of a polymer coating and (2) an closed-end wrench of claim 7.

15. The kit of claim 14, further comprising a threaded nut fastener comprising polygonal outer surface and a threaded helical inner surface for securing a bolt or screw, wherein the outer surface consists of a polymer coating.

16. A piston ring compressor for compressing piston rings about a piston, wherein the portion of the ring compressor which contacts the piston rings comprises a polymer coating.

17. The ring compressor of claim 16, wherein the polymer is selected from the group consisting of a polyisocyanate, a polyurethane, a polyester, a polyethylene, an UHMWPE, a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, an ABS alloy, a fluoropolymer, an ionomer resin, a polyamide, a polyimide, a polyamideimide, a vinyl acetate, a co-polymer thereof, a polymer blend thereof or a combination thereof.

18. The ring compressor of claim 17, wherein the polymer is a fluoropolymer

19. The ring compressor of claim 18, wherein the fluoropolymer is a polytetrafluoroethylene (PTFE), a perfluoroalkoxy (PFA), an ethylene tetrafluoroethylene (ETFE), a fluorinated ethylene propylene (FEP) or a polyvinylidene fluoride (PVDF).

20. The ring compressor of claim 17, wherein the polymer is polyamide.
